(19) United States
(12) Patent Application Publication
(10) Pub. No.: US 2025/0375968 A1
(43) Pub. Date: Dec. 11, 2025

(54) LIQUID STORAGE APPARATUS, CONTROL METHOD, AND SYSTEM

(71) Applicant: CANON KABUSHIKI KAISHA, Tokyo (JP)

(72) Inventors: KENTA IIMURA, Tokyo (JP); HIROMASA YONEYAMA, Kanagawa (JP); DAIGO KURONUMA, Kanagawa (JP); HIDEYUKI NOZAWA, Tochigi (JP); TOMOYUKI NAGASE, Kanagawa (JP); YUTO NITAMI, Kanagawa (JP); AKIRA FUJIKAKE, Kanagawa (JP); RYOHEI MARUYAMA, Kanagawa (JP); MASAKAZU NAGASHIMA, Kanagawa (JP); KICHINOSUKE HIROKAWA, Tokyo (JP); NAOAKI WADA, Kanagawa (JP)

(21) Appl. No.: 19/222,941

(22) Filed: May 29, 2025

(30) Foreign Application Priority Data
Jun. 5, 2024 (JP) 2024-091596

(51) Int. Cl. B41J 2/20; B01F 31/31; B01F 35/513; B01F 35/60; B01F 35/75; B01F 101/35; B41J 2/175

(52) U.S. Cl. CPC B41J 2/20; B01F 31/311; B01F 35/513; B01F 35/6052; B01F 35/7547; B41J 2/17523; B41J 2/17596; B01F 2101/35

(57) ABSTRACT

A liquid storage apparatus includes a storage unit configured to extractably store a liquid container with flexibility, a path forming unit connected to the liquid container stored in the storage unit and configured to form a path configured to flow a liquid out of the liquid container, and a pressing unit configured to press the liquid container stored in the storage unit. The pressing unit is configured to perform a stirring operation of stirring the liquid stored in the liquid container by repeating pressing of the liquid container and reducing of the pressing, and a regulating operation of maintaining a state in which the liquid container is pressed and regulating extraction of the liquid container from the storage unit.

### BACKGROUND

### Field of the Technology

The present disclosure relates to a liquid storage apparatus, a control method, and a system.

### Description of the Related Art

As a liquid storage method, a liquid container having flexibility is known. Such a liquid container can be used as a liquid container that stores, for example, ink. Japanese Patent Laid-Open No. 2021-17022 discloses a liquid injection apparatus that can place a bag-shaped container on a case and detachably attach it to an attachment portion.

In the configuration in which the liquid container can be detached, if the liquid container is detached at an inappropriate timing, as in a case where the liquid container is detached during liquid supply, the liquid may leak to the periphery, or air may enter a path. In addition, the liquid stored in the liquid container may cause separation of components along with the elapse of time, and it is demanded to maintain evenness.

### SUMMARY

The present disclosure provides a technique of preventing a liquid container from being detached at an inappropriate timing.

According to one aspect of the present disclosure, there is provided a liquid storage apparatus comprising: a storage unit configured to extractably store a liquid container with flexibility; a path forming unit connected to the liquid container stored in the storage unit and configured to form a path configured to flow a liquid out of the liquid container; and a pressing unit configured to press the liquid container stored in the storage unit, wherein the pressing unit is configured to perform: a stirring operation of stirring the liquid stored in the liquid container by repeating pressing of the liquid container and reducing of the pressing; and a regulating operation of maintaining a state in which the liquid container is pressed and regulating extraction of the liquid container from the storage unit.

Features of the present disclosure will become apparent from the following description of embodiments with reference to the attached drawings. The following description of embodiments are described by way of example.

### BRIEF DESCRIPTION OF THE DRAWINGS

FIG. 1 is a perspective view of a system according to an embodiment of the present disclosure;

FIG. 2A is a front view of the system shown in FIG. 1;

FIG. 2B is an explanatory view showing the internal structure of a liquid discharge apparatus;

FIG. 3 is a partially exploded perspective view of a liquid storage apparatus;

FIG. 4 is a perspective view of a liquid container and a support unit;

FIG. 5 is an operation explanatory view of a handle and a lock mechanism;

FIG. 6 is an operation explanatory view of the lock mechanism;

FIG. 7 is a view showing the attachment posture and the insertion/removal mode of the support unit to a slot;

FIG. 8 is an operation explanatory view of a pressing unit;

FIG. 9 is an operation explanatory view of the pressing unit;

FIG. 10 is an explanatory view of a cam;

FIG. 11 is a perspective view of a case with a stirring function and the support unit in a separated state;

FIG. 12 is a perspective view of the case with a stirring function and the support unit in an attached state;

FIG. 13A is an explanatory view of a stirring operation;

FIG. 13B is an explanatory view of a stirring operation;

FIG. 14A is an explanatory view showing an example in which the support unit is abruptly extracted;

FIG. 14B is an explanatory view of a regulating operation;

FIG. 15 is a block diagram of the control circuit of the system shown in FIG. 1;

FIGS. 16A to 16C are flowcharts showing a control example;

FIG. 17A is a view showing an example of the configuration of a recovery unit;

FIG. 17B is a flowchart showing a control example;

FIG. 18 is an explanatory view of a regulating operation according to another embodiment;

FIG. 19 is an explanatory view of a regulating operation according to still another embodiment;

FIG. 20 is an explanatory view of an example of the operation of a passage valve; and

FIGS. 21A and 21B are flowcharts showing a control example.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

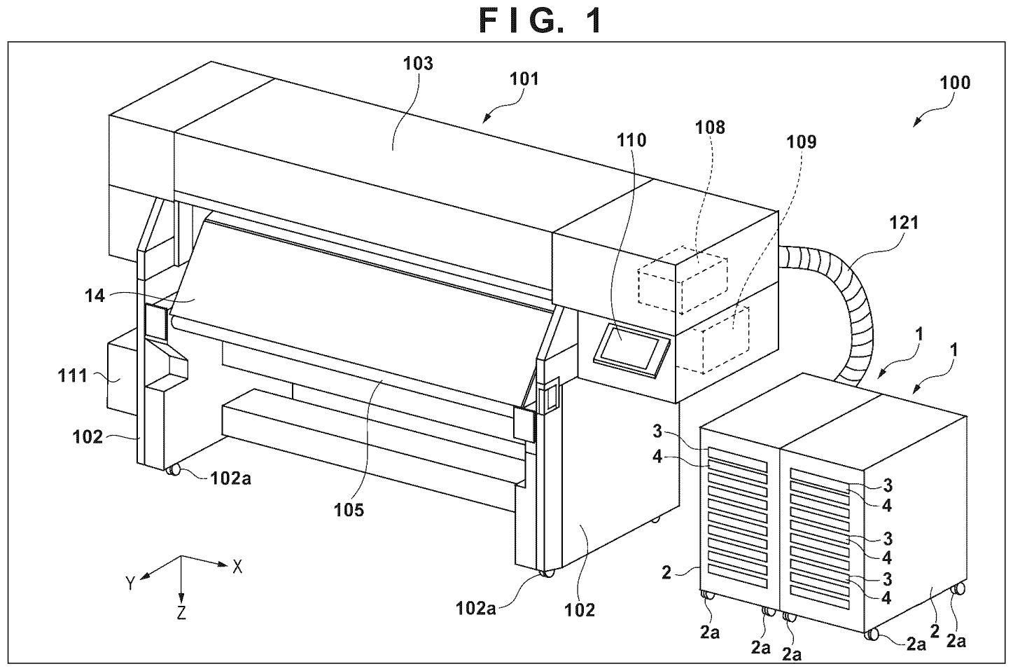

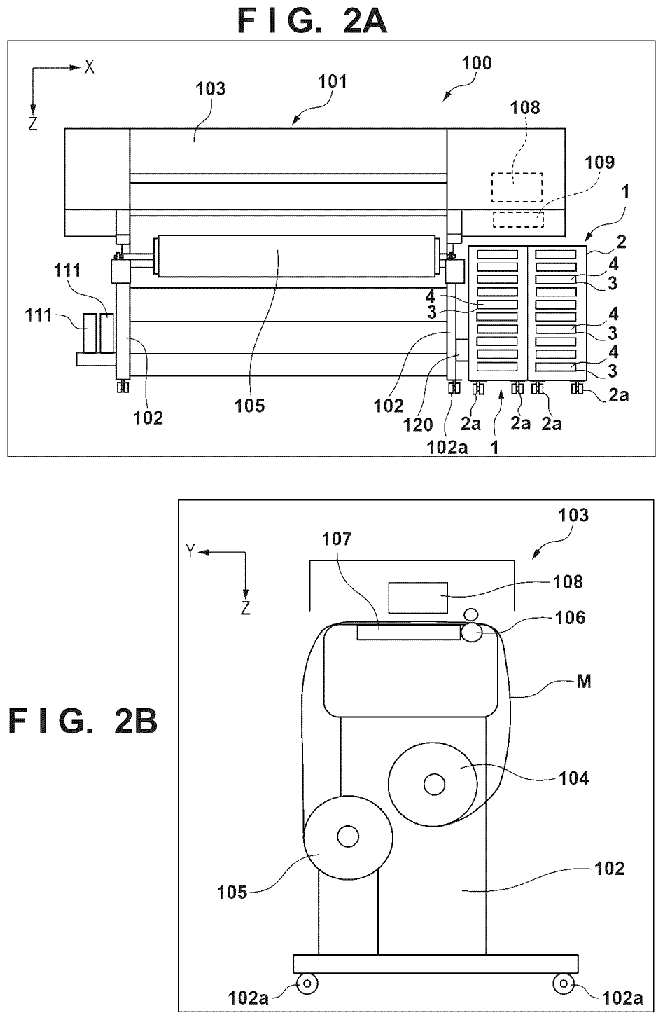

FIG. 1 is a perspective view of a system 100 according to an embodiment of the present disclosure, and FIG. 2A is a front view of the system 100. In the drawings, arrows X, Y, and Z indicate directions crossing each other, and in this embodiment, the directions are orthogonal to each other. The left-right direction in a case where the system 100 is installed on a horizontal surface is the X direction, the front-back direction is the Y direction, and the upward-downward direction is the Z direction. In addition, the right side when the system 100 is viewed from the front is the +X direction, the left side is the −X direction, the near side is the +Y direction, the far side is the −Y direction, the lower side (downward in the gravity direction) is the +Z direction, and the upper side (upward in the gravity direction) is the −Z direction.

The system 100 according to this embodiment is a printing system that includes a liquid storage apparatus 1 and a liquid discharge apparatus 101, and prints an image by discharging ink to a print medium such as paper. The liquid storage apparatus 1 is a liquid containing apparatus in terms of containing a liquid. In this embodiment, two liquid storage apparatuses 1 are provided while being connected to each other. The liquid discharge apparatus 101 and the two liquid storage apparatuses 1 are arranged side by side in the X direction. A liquid that the liquid storage apparatuses 1 supply to the liquid discharge apparatus 101 is ink, and the liquid discharge apparatus 101 is a printing apparatus that discharges the ink to the print medium. However, the present disclosure is not limited to the printing system, and can also be applied to various kinds of liquid discharge systems aiming at discharging a liquid to a medium.

Note that “printing” is not limited to formation of significant information such as a character or figure, and includes, in a broad sense, to form an image, design, pattern, or the like on a print medium or process a medium regardless of whether information is significant or insignificant, or whether information is so visualized as to allow a person to visually perceive it. Also, in this embodiment, the “print medium” is assumed to be sheet-shaped paper but may be a cloth, a plastic film, or the like.

### <Liquid Discharge Apparatus>

The liquid discharge apparatus 101 will be described with reference to FIG. 2B in addition to FIGS. 1 and 2A. FIG. 2B is an explanatory view of the internal structure of the liquid discharge apparatus 101. The liquid discharge apparatus 101 includes a pair of left and right stands 102, and a main body 103 supported on the pair of stands 102. Each stand 102 is provided with casters 102a, and the liquid discharge apparatus 101 can be relatively easily moved on the floor. A feeding unit 104 and a winding unit 105 are arranged under the main body 103. In this embodiment, a print medium M is roll paper, and the feeding unit 104 includes a shaft on which the print medium Mis wound. The winding unit 105 includes a shaft for winding up the print medium M. In this embodiment, roll paper has been exemplified as the print medium M, but it may be cut paper.

A conveyance unit 106 is provided in the main body 103. The conveyance unit 106 includes a driving roller and a driven roller, and the print medium M fed from the feeding unit 104 is sandwiched in the nip portion between the rollers. When the driving roller rotates, the print medium Mis conveyed onto a platen 107. A discharge head 108 is arranged facing the platen 107. The discharge head 108 is a printhead that discharges ink to form an image. The discharge head 108 discharges the ink to the print medium M conveyed onto the platen 107, thereby forming an image on the print medium M.

The discharge head 108 includes, for example, a discharge energy generation element such as an electrothermal transducer (heater) or a piezoelectric element, and discharges ink from an orifice. If the electrothermal transducer is used, ink can be foamed by generated heat and discharged from the orifice using the foaming energy. The printing method of the discharge head 108 can be a serial scan method or a full-line method. In a case of the serial scan method, the discharge head 108 is mounted on a carriage and reciprocally moved in the X direction. Discharging ink while moving the discharge head 108 in the X direction is called print scanning. The conveyance operation of the print medium M and print scanning of the discharge head 108 are alternately repeated, thereby printing an image on the print medium M. In this embodiment, employment of the serial scan method is assumed. In a case of the full-line method, a long discharge head 108 extending in the X direction is used, and an image is printed while continuously conveying the print medium M.

The print medium M with the image printed thereon is wound up by the winding unit 105. A drying unit 14 reduces liquid components contained in the ink applied, by the discharge head 108, to the print medium M, thereby increasing the fixing properties between the print medium M and the ink. The drying unit 14 includes a heat source such as a heater, and a blower mechanism such as a fan, and applies hot air at least from the ink application surface side to the passing print medium M, thereby drying the print medium M. Note that as for the drying method, not only the method of applying hot air but also a method of irradiating the surface of the print medium M with an electromagnetic wave (ultraviolet rays or infrared rays) or a heat conduction method using contact of a heat generating body may be used in combination. In addition, the drying unit 14 may only blow air without having any heat source. The print medium M with the image printed thereon is cut by a user using scissors or automatically cut by a cutter (not shown).

A recovery unit 109 is arranged in the main body 103. The recovery unit 109 is arranged outside the print region (outside the discharge region) of the discharge head 108, and performs processing associated with recovery and maintaining of the discharge performance of the discharge head 108. Examples of the processing are preliminary discharge of discharging a predetermined amount of ink before and after a printing operation and processing of sucking remaining ink or the like from the orifices of the discharge head 108. The discharge head 108 is moved onto the recovery unit 109, as shown in FIG. 2A, if recovery processing is necessary.

In this embodiment, the stands 102 are arranged at positions slightly outside in the ±X directions with respect to the width of the print medium M because these support the feeding unit 104 and the winding unit 105 of heavy weight while supporting the main body 103. The main body 103 incorporating the recovery unit 109 projects to the outer side of the stand 102 in the +X direction. The main body 103 also projects to the outer side of the print medium M in the −X direction on the opposite side. A mechanism configured to move a carriage (not shown) with the discharge head 108 mounted thereon is incorporated here.

An operation panel 110 is provided on the front surface of the main body 103. Also, the operation panel 110 is, for example, a touch panel and can accept input of various kinds of settings concerning printing and display the state of a print job.

The liquid discharge apparatus 101 is also provided with a waste liquid cartridge 111. The waste liquid cartridge 111 is arranged under an end portion of the main body 103 on the opposite side (−X side) of the liquid storage apparatuses 1 in the X direction. When the waste liquid cartridge 111 is arranged on the lower side of the portion of the main body 103 projecting in the −X side, the installation area of the liquid discharge apparatus 101 can be made small.

A waste liquid (waste ink, or the like) sucked by the recovery unit 109 flows into the waste liquid cartridge 111 to be collected. The waste liquid cartridge 111 may be arranged near the recovery unit 109. In this embodiment, however, the waste liquid cartridge 111 is arranged in a free space under the end portion of the main body 103, thereby reducing the installation area of the liquid discharge apparatus 101.

### <Liquid Storage Apparatus>

FIGS. 1 and 2A will be referred to. The liquid storage apparatus 1 is a liquid supply apparatus that stores a liquid such as ink to be discharged from the discharge head 108 and supplies the liquid such as ink to the liquid discharge apparatus 101. The liquid storage apparatus 1 includes a box-shaped main body 2 that forms a plurality of storage portions 3. Casters 2a are provided on the bottom surface of the main body 2, and the liquid storage apparatus 1 can be relatively easily moved on the floor. The liquid storage apparatus 1 includes the plurality of storage portions 3 arrayed in the Z direction. Each storage portion 3 has a form of a slot opening to an outer wall portion 2b of the main body 2. The outer wall portion 2b forms the housing of the main body 2. In each storage portion 3, a support unit 4 is detachably inserted in the Y direction. The support unit 4 exchangeably supports a liquid container 200 (to be also simply referred to as a container 200) to be described later. In each storage portion 3, the container 200 supported by the support unit 4 is stored.

Each storage portion 3 is provided with a tube that connects the container 200 and the liquid discharge apparatus 101. Each tube is connected to the liquid discharge apparatus 101 through a single hose 121 that stores all tubes. Ink in the container 200 is supplied to the discharge head 108 via the tube.

The height of the liquid storage apparatus 1 is set to be lower than the lower surface of the end portion of the main body 103 of the liquid discharge apparatus 101 projecting to the +X side. For this reason, as shown in FIG. 2A, the liquid storage apparatus 1 can be stored under the main body 103. The liquid storage apparatus 1 can be moved close to a position where it contacts the stand 102 in the X direction. As shown in FIG. 2A, the liquid storage apparatus 1 can be fixed to the stand 102 using a connecting member 120. When moving the system 100, the liquid discharge apparatus 101 and the liquid storage apparatus 1 can be moved integrally.

Since the two liquid storage apparatuses 1 are provided, the system 100 according to this embodiment can use more containers 200. When increasing the number of ink colors for the purpose of raising image quality or increasing the amount of ink of the same color for the purpose of attaining high productivity, providing the plurality of liquid storage apparatuses 1 is advantageous. In this case, when a layout in which some or all of liquid storage apparatuses 1 overlap the liquid discharge apparatus 101 in the X direction, as in this embodiment, is employed, the installation area of the system 100 can be made small. Note that in this embodiment, one of the two liquid storage apparatuses 1 falls within the size of the liquid discharge apparatus 101 in the X direction. If the number of liquid storage apparatuses is two or more, the size is such that there is a slight protrusion from the system 100 in the X direction.

### <Liquid Container and Support Unit>

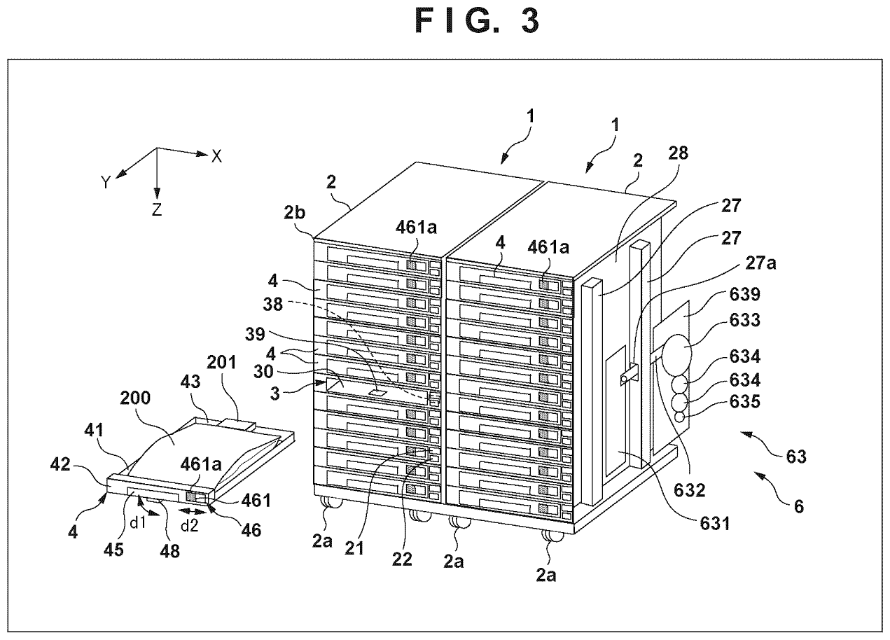

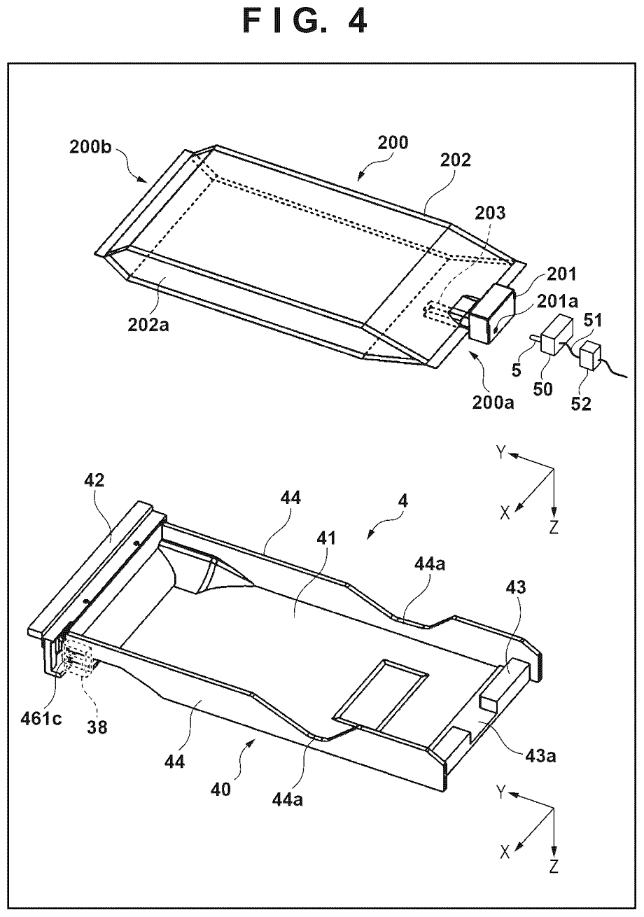

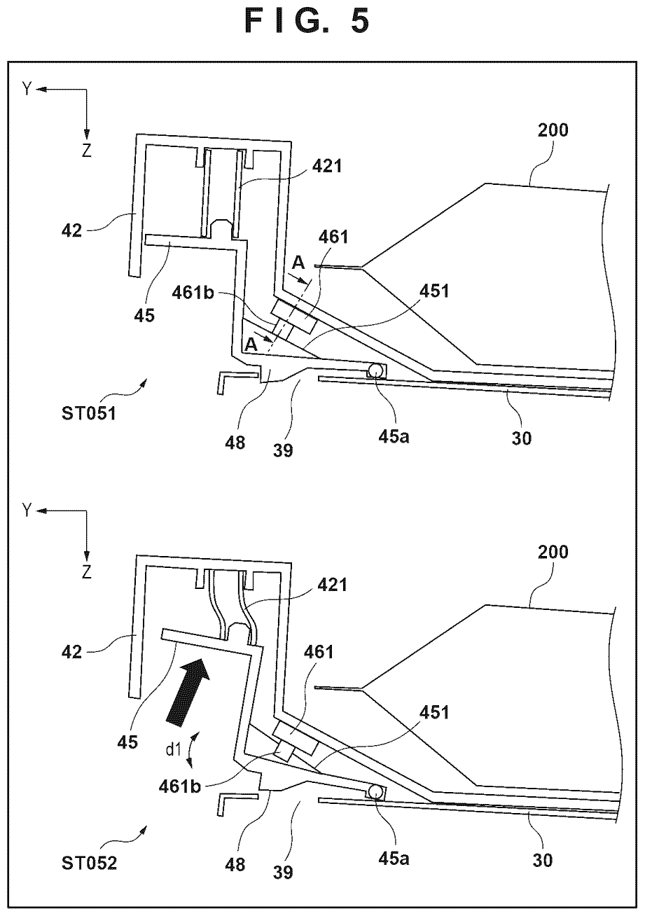

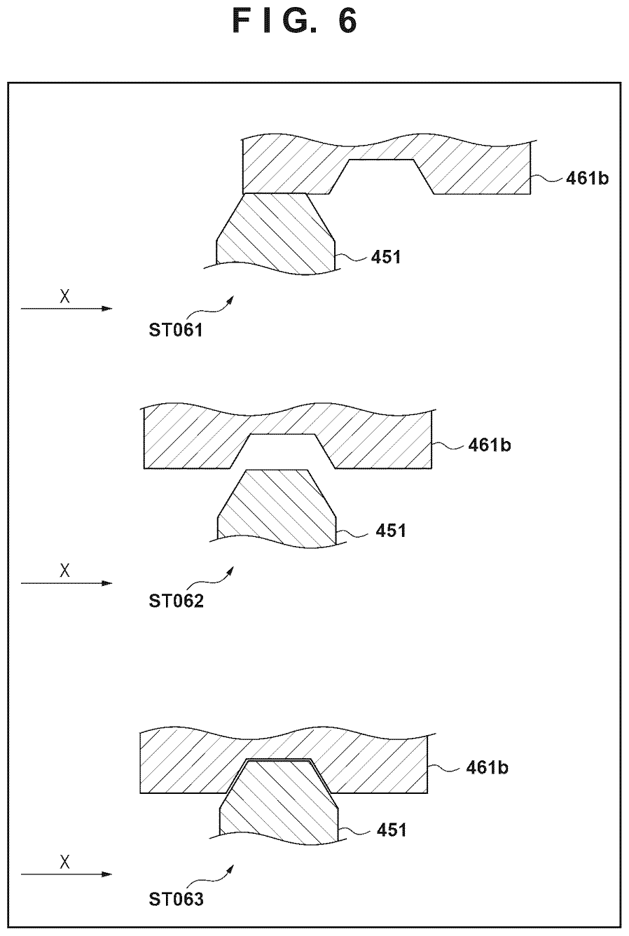

FIGS. 3 to 6 will be referred to. FIG. 3 is a partially exploded perspective view of the liquid storage apparatus 1 and shows a state in which one support unit 4 is detached from a corresponding storage portion 3. FIG. 3 also shows a state in which one side wall portion of the outer wall portion of the liquid storage apparatus 1 is detached, and the internal mechanism is exposed. FIG. 4 is a perspective view of the container 200 and the support unit 4. FIG. 5 is an operation explanatory view of a handle 45 and a lock mechanism 46. FIG. 6 is an operation explanatory view of the lock mechanism 46 and corresponds to a sectional view taken along a line A-A in FIG. 5.

The container 200 includes a bag 202 made of a material with flexibility. Gusset portions 202a folded inside are provided on both side surfaces of the bag 202 to increase the liquid storage amount. The bag 202 is formed into a bag shape by welding sheets forming the upper and lower surfaces and sheets forming the gusset portions 202a to each other, thereby forming a flexible tank for storing a liquid. The shape of the bag 202 changes in accordance with the stored liquid amount such that if the liquid amount remaining inside is large, the gusset portions 202a expand, and if the liquid amount remaining inside is small, the gusset portions 202a are folded inside. The material of the bag 202 is, for example, a material having a multiple-layer structure such as PET. If the liquid inside has a property of reacting with air and sticking, or there is concern that the concentration or remaining amount changes due to evaporation, a layer material including an aluminum layer is advantageous as the material of the bag 202.

The container 200 has one end portion 200a and the other end portion 200b in the longitudinal direction. In an attached state to the liquid storage apparatus 1, the end portion 200a is located on the far side of the liquid storage apparatus 1, and the end portion 200b is located on the near side. An outlet member 201 is provided at the end portion 200a. In the outlet member 201, a supply port 201a communicating with an intake port 203 inside the bag 202 is formed. The liquid stored in the bag 202 flows to the outside via the intake port 203 and the supply port 201a. A spring biased-type supply port control valve that opens/closes the supply port 201a is provided in the outlet member 201. By the supply port control valve, the supply port 201a is normally maintained in the closed state.

In the container 200, the side provided with the outlet member 201 has a length of, for example, about 180 mm, and the side (side surface) orthogonal to this side has a length of, for example, about 400 mm. In the container 200, for example, about 1.5 L liquid is stored. Note that the side with the outlet member 201 may be not the short side but the long side. Also, the bag 202 may have not a rectangular shape but a square shape in a planar view.

The main body 2 includes, on the far side of the storage portion 3, a needle-type path forming member 5 to be inserted into the supply port 201a. The path forming member 5 is provided for each storage portion 3. If the path forming member 5 is inserted into the supply port 201a and connected, the supply port control valve is opened by the insertion of the path forming member 5. The path forming member 5 is supported by a block-shaped support member 50 and is also connected to a tube 51. The path forming member 5 forms a path that flows the liquid stored in the bag 202 to the liquid discharge apparatus 101 that is the supply destination, and the liquid that has flowed out to the path forming member 5 is supplied to the liquid discharge apparatus 101 via the tube 51. An electrically driven passage valve 52 is provided on a midway part of the tube 51. When the passage valve 52 is opened, the path formed by the tube 51 is opened. When the passage valve 52 is closed, the path formed by the tube 51 is closed.

The support unit 4 includes a support portion 40 that supports the container 200, and has a form of a tray, as a whole, on which the container 200 in a lying posture is placed. The support unit 4 can displace substantially in the Y direction between a storage position where the container 200 is stored in the main body 2 and an extraction position where the container 200 is exposed to the outside of the main body 2. In FIG. 3, one support unit 4 is located at the extraction position, and all the remaining support units 4 are located at the storage position. At the extraction position, the container 200 can be exchanged. At the storage position, the liquid stored in the container 200 can be supplied to the liquid discharge apparatus 101. In this embodiment, at the extraction position, the support unit 4 is apart from the storage portion 3. However, the extraction position may be a position where the end portion of the support unit 4 is held inside the storage portion 3, and can be any position where the container 200 can be exchanged with respect to the support unit 4.

The support portion 40 includes a placement surface 41 on which the container 200 is placed, and the four sides of the placement surface 41 are defined by left and right side plates 44, a front end portion 42, and a rear end portion 43. A notch portion 44a is formed in each side plate 44. A concave portion 43a on which the outlet member 201 is arranged is formed at the rear end portion 43.

At the front end portion 42, the handle 45 that is rotatable about a shaft 45a extending in the X direction is provided, and the user can rotate the handle 45 in a direction d1. The handle 45 also serves as an operation handle of an engaging portion 48. The handle 45 is provided with the engaging portion 48, and an engaging portion 39 that engages with the engaging portion 48 is formed on the bottom portion of a case 30 that forms the storage portion 3. In this embodiment, the engaging portion 48 is a projecting portion, and the engaging portion 39 is a concave portion in which the engaging portion 48 is inserted.

The engaging portion 48 and the engaging portion 39 form a regulating structure that regulates displacement of the support unit 4 from the storage position to the extraction position. When the engaging portion 48 and the engaging portion 39 engage with each other, the support unit 4 is attached to the storage portion 3, and the support unit 4 located at the storage position can be prevented from dropping from the storage portion 3 even if a vibration acts on it due to, for example, movement of the liquid storage apparatus 1.

The handle 45 is always biased, by an elastic member 421, to the side of the engaging position (the position in a state ST051 shown in FIG. 5) where the engaging portion 48 engages with the engaging portion 39. The elastic member 421 is, for example, a coil spring. When the user grasps the handle 45 and rotates it in a direction indicated by an arrow in a state ST052 in FIG. 5, the engaging portion 48 and the engaging portion 39 are disengaged, and the support unit 4 inserted into the storage portion 3 can be extracted from the storage portion 3.

To prevent the support unit 4 attached to the storage portion 3 from being accidentally extracted, the lock mechanism 46 that locks the support unit 4 at the storage position is provided for each storage portion 3. The lock mechanism 46 includes a slide member 461 incorporated in the front end portion 42. To allow the user to operate the slide member 461, an operation portion 461a that is a part thereof is exposed from the front end portion 42. The slide member 461 is provided to be movable in the direction of an arrow d2 (X direction) between a lock position where rotation of the handle 45 in the direction d1 is regulated and an unlock position where rotation of the handle 45 is permitted.

The state ST051 in FIG. 5 and a state ST061 in FIG. 6 indicate a state in which the slide member 461 is located at the lock position. That is, the lock mechanism 46 in in a locked state. The slide member 461 includes an abutment portion 461b, and the abutment portion 461b abuts against an abutment portion 451 provided like a rib in the handle 45. In the state ST051 shown in FIG. 5 and the state ST061 shown in FIG. 6, the slide member 461 is an obstacle that impedes rotation of the handle 45 in the disengaging direction. It is therefore impossible to extract the support unit 4 from the storage portion 3.

A state ST062 in FIG. 6 indicates a state in which the slide member 461 is located at the unlock position. That is, the lock mechanism 46 is in an unlocked state. The notch portion of the abutment portion 461b and the abutment portion 451 are located at positions where they face each other. At this time, as indicated by a state ST063 in FIG. 6, since the abutment portion 451 can escape to the notch portion of the abutment portion 461b, the handle 45 can be rotated in the disengaging direction, as indicated by a state ST052 in FIG. 5. When the user slides the slide member 461 to the unlock position and then operates the handle 45, the support unit 4 can be extracted from the storage portion 3.

The storage portion 3 is provided with a sensor 38 that detects the position of the slide member 461. The sensor 38 is, for example, an optical sensor (for example, a photo interrupter) capable of detecting a detection piece 461c of the slide member 461. If the slide member 461 is located at the lock position, the detection piece 461c is located at the detection position of the sensor 38, as shown in FIG. 4, and is detected by the sensor 38. If the slide member 461 is located at the unlock position, the detection piece 461c is not located at the detection position of the sensor 38 and is not detected by the sensor 38. Thus, based on the detection result of the sensor 38, it can be determined whether the position of the slide member 461 is the lock position or the unlock position, that is, whether the lock mechanism 46 is in the locked state or the unlocked state.

Opening/closing of the passage valve 52 can be synchronized with the detection result of the sensor 38. For example, if the sensor 38 detects that the position of the slide member 461 is the unlock position in a case where the passage valve 52 is in an open state, the passage valve 52 is immediately closed in synchronism with the detection. This can prevent the support unit 4 from being extracted from the storage portion 3 in a state in which the passage valve 52 is open. If the support unit 4 is extracted from the storage portion 3 in the state in which the passage valve 52 is released, air may enter from the path forming member 5 into the tube 51. This causes sticking of the liquid in the tube 51 or a discharge failure in the discharge head 108. If it is detected that the position of the slide member 461 is the unlock position, the passage valve 52 is immediately closed by automatic control in synchronism with the detection, thereby preventing air from entering the tube 51.

### (Indicator Device)

An indicator device provided in the liquid storage apparatus 1 will be described with reference to FIG. 3. On the main body 2, a state indicator 21 and a type indicator 22 are provided for each storage portion 3. The state indicator 21 and the type indicator 22 are arranged on the outer wall portion 2b to be adjacent to the opening of the corresponding storage portion 3. In this embodiment, the state indicator 21 is an electronic indicator and makes a notification concerning the state of the container 200 attached to the corresponding storage portion 3. More specifically, the state indicator 21 is formed by, for example, two light emitting elements. The two light emitting elements are, for example, LEDs of different light emission colors. The two light emitting elements are independently driven, and the drive mode is switched between light-on, blinking, and light-off. It is possible to notify the user of the state of the corresponding container 200 by combining drive modes (for example, light-on and blinking, light-on and light-off, blinking and light-off, or the like).

The state of the container 200 to be notified to the user is, for example, the remaining amount of the liquid in the container 200. The consumed amount (discharge amount) of the liquid stored in the container 200 can be estimated from the discharge control amount of the discharge head 108. The remaining amount of the liquid in the container 200 is estimated based on the estimated consumed amount, and if the remaining amount is less than a threshold, one of the two light emitting elements is made to blink. Thus, the user can be notified of the exchange time of the container 200 and promoted to prepare the container 200 that is full of liquid.

The type indicator 22 indicates information concerning the type of the liquid assigned to the corresponding storage portion 3. The type indicator 22 may be an electronic indicator. In this embodiment, however, it is a nonelectronic indicator and is a plate material or sheet (color label) made of paper or plastic with the color of the liquid. By the type indicator 22, the user can visually understand to which storage portion 3 the container 200 storing what kind of liquid should be attached.

### (Tilt of Slot)

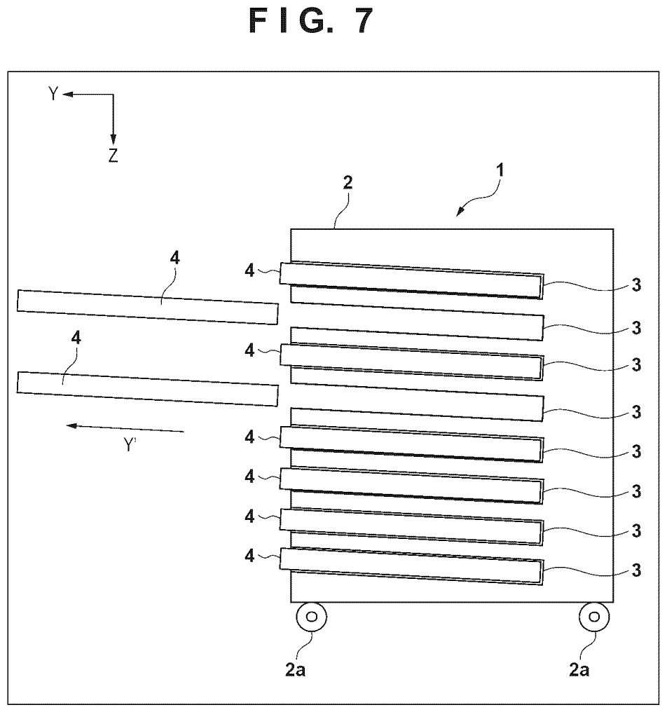

FIG. 7 is a view showing the attachment posture and the insertion/removal mode of the support unit 4 to the storage portion 3. As shown in FIG. 7, the storage portion 3 of each stage provided in the liquid storage apparatus 1 is tilted and lowered to the lower (+Z) side toward the rear side (far side or −Y side). Hence, in the attached state, the support unit 4 is held in a tilting posture, and in the container 200, the end portion 200a is located on the lower side of the end portion 200b in the gravity direction (Z direction). The effect will be described later. The tilt angle is, for example, smaller than 45° with respect to the horizontal plane and particularly 10° or less. In the example shown in FIG. 7, the tilt angle is assumed to be 3°.

### (Liquid Stirring Mechanism)

Various kinds of liquids can be stored in the container 200 and used for image printing, maintenance of the discharge head 108, or the like. For example, a solvent-based ink such as an aqueous ink, a latex ink, or an eco-solvent can be stored in the container 200. Depending on the type of ink, the color material (pigment component or the like) in ink may be sedimented along with the elapse of time. The particle size of a color material or the type and amount of an additive may change between ink colors, and the sedimentation speed may change depending on the ink color. Also, a reaction liquid that is discharged from the discharge head 108 and reacts with ink to fix the ink on the surface of the print medium M can also be stored in the container 200. For the container 200 storing a liquid having a characteristic that its components are separated, the stored liquid is appropriately stirred, thereby improving evenness. This contributes to, for example, preventing lowering of quality of a printed image.

In this embodiment, the bag 202 of the container 200 is physically pressed from the outside and deformed. The stored liquid is thus flowed in the bag 202 and stirred. Depending on the liquid stored in the container 200, it need not be stirred. In this embodiment, the storage portions 3 having a stirring function and the storage portions 3 without the stirring function are provided. More specifically, the storage portions 3 at the upper stages do not have the stirring function, and the storage portions 3 at the middle to lower stages have the stirring function. All storage portions 3 may have the stirring function, as a matter of course.

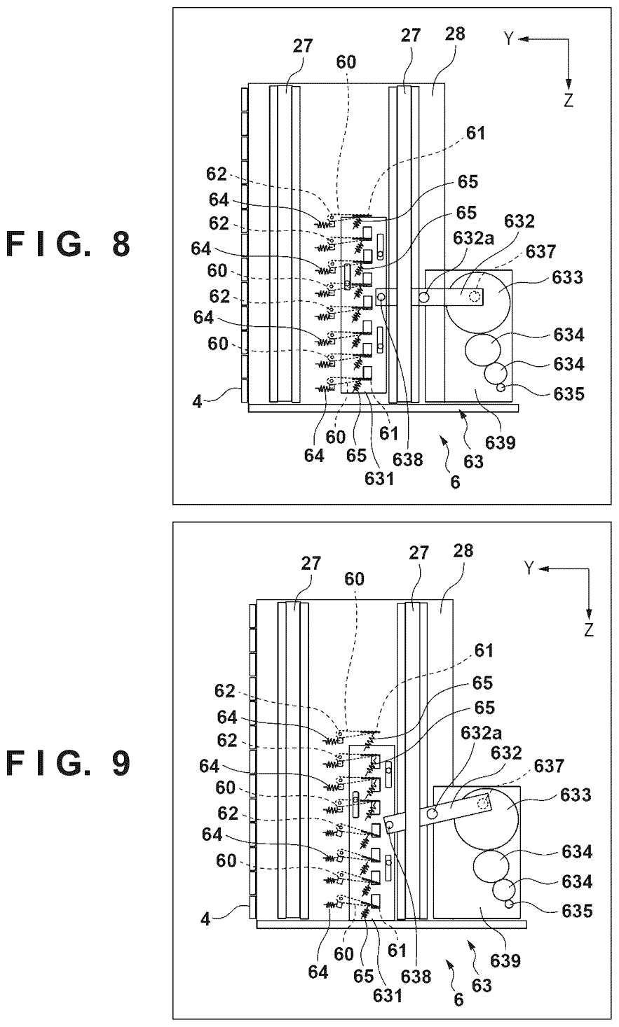

The configuration of a pressing unit 6 that implements the stirring function will be described with reference to FIGS. 3, 8, and 9. FIGS. 8 and 9 are operation explanatory views of the pressing unit 6 when the main body 2 is viewed from sideward. The pressing unit 6 includes a plurality of pressing members 60, and a moving mechanism 63 common to the plurality of pressing members 60. The pressing member 60 is provided for each storage portion 3. The pressing member 60 is arranged at a position facing the support unit 4 attached to the storage portion 3 and the container 200 supported by the support unit 4. When the moving mechanism 63 synchronously rotates each pressing member 60 about a rotation shaft 62, a pressing portion 61 provided on the pressing member 60 presses the container 200 from above and reduces or relaxes the pressing. FIG. 8 shows a state in which the pressing portion 61 (and the pressing member 60) are located at a pressing reducing position (or pressing relaxing position), and FIG. 9 shows a state in which the pressing portion 61 (and the pressing member 60) are located at a pressing position.

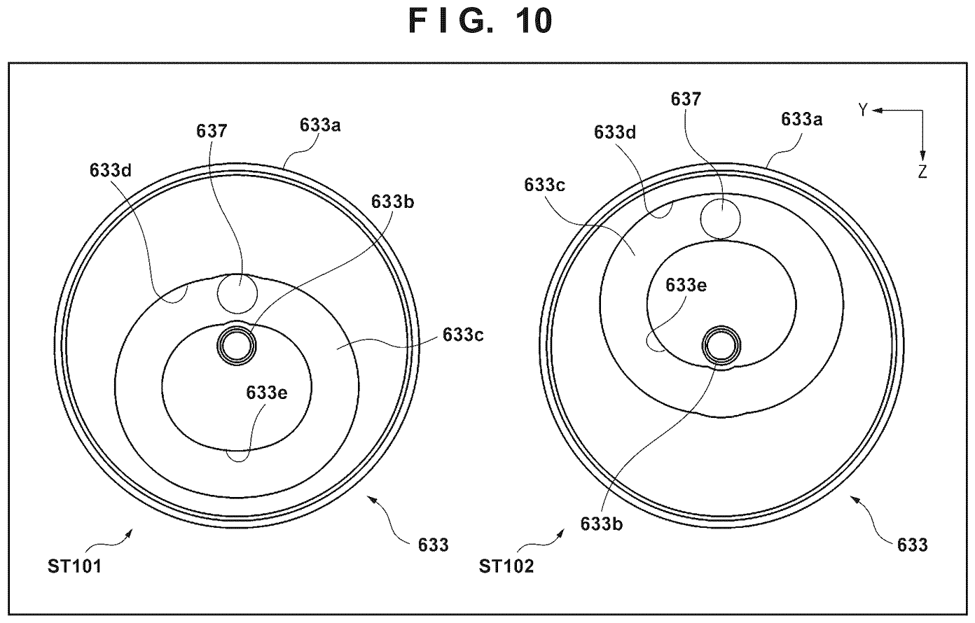

The configuration of the moving mechanism 63 will be described. The output of a motor 635 that is the driving source of the moving mechanism 63 is transmitted to a cam 633 via a plurality of gears 634. Note the rotation shaft of each component is in the X direction. The configuration of the cam 633 will be described here with reference to FIG. 10. FIG. 10 is an explanatory view of the cam 633, and a state ST101 shown in FIG. 10 indicates a state in which the cam 633 has rotated by 180° from a state ST102 in FIG. 10.

The cam 633 is a disc-shaped member that can rotate about a shaft 633b in the X direction, and a gear tooth portion 633a is formed on the outer peripheral surface. The gear tooth portion 633a meshes with the gear 634, and the cam 633 rotates when the gear 634 rotates. A groove 633c is formed in the side surface of the cam 633, and the outer and inner side surfaces of the groove 633c form an outer cam surface 633d and an inner cam surface 633e, respectively. In the groove 633c, a cam follower 637 connected to a driving transmission lever 632 is arranged. The inner cam surface 633e is located on the inner side of the cam follower 637 in the radial direction of the cam 633, and when the cam 633 rotates, the inner cam surface 633e comes into contact with the cam follower 637 and acts to move the cam follower 637 upward. Also, the outer cam surface 633d is located on the outer side of the cam follower 637 in the radial direction of the cam 633, and when the cam 633 rotates, the outer cam surface 633d comes into contact with the cam follower 637 and acts to move the cam follower 637 downward.

FIGS. 3, 8, and 9 will be referred to again. When the cam follower 637 moves up/down in accordance with the rotation of the cam 633, the driving transmission lever 632 rotates about a rotation shaft 632a. Since the driving transmission lever 632 is rotatably connected to a shaft portion 638 provided on an elevating member 631, the operation of the driving transmission lever 632 is converted into the elevating operation of the elevating member 631. When the cam 633 rotates by one revolution, the cam follower 637 performs a reciprocating operation once in the Z direction, and therefore, the elevating member 631 similarly performs a reciprocating elevating operation once via the driving transmission lever 632.

The elevating member 631 having a plate shape is attached to a side plate 28 of the main body 2 such that it can move up/down in the Z direction. In addition, two, front and rear columns 27 each having a U-shaped section and extending in the Z direction are fixed on the side plate 28. The columns 27 are attached to the side plate on the −X side as well, and the main body 2 ensures its strength as a structure by the total of four columns 27. The weight of a number of containers 200 can thus be supported.

The column 27 has a high strength and a thickness. Hence, if the moving mechanism 63 is provided outside in the X direction with respect to the columns 27 attached to the side plate 28, the size in the X direction becomes large. Hence, in this embodiment, the elevating member 631 and the driving mechanism of the cam 633 and the like are distributed to the front and rear sides of one the column 27 in the Y direction. The driving transmission lever 632 is inserted into a through hole 27a formed in the one column 27.

This makes it possible to suppress an increase of the size of the main body 2 in the X direction and arrange the moving mechanism 63 of the pressing unit 6 while ensuring the strength. Furthermore, the driving transmission lever 632 is attached to a plate-shaped support member 639 that supports the moving mechanism 63. By detaching fixing elements such as fastening screws, most components of the moving mechanism 63 can be detached to the rear surface side of the main body 2 as an integrated unit together with the support member 639. Hence, parts exchange by a service man can easily be performed. Note that fastening and unfastening of the fixing elements such as fastening screws can easily be done by fastening these from the rear surface side of the main body 2.

Biasing forces of two springs 64 and 65 act on each pressing member 60. The spring 64 has one end attached to the pressing member 60 and the other end attached to the storage portion 3 (case 30). Also, the spring 65 has one end attached to the pressing member 60 and the other end attached to the elevating member 631. The pressing member 60 is a movable member (particularly a rotating member) that is attached to the storage portion 3 (case 30) such that it can rotate about the rotation shaft 62 as the rotation center. The rotation shaft 62 is a shaft in a direction crossing the moving direction (Z direction) of the pressing portion 61. Both the two springs 64 and 65 bias the pressing member 60 in a direction to rotate it clockwise in FIGS. 8 and 9.

When the pressing member 60 is at the pressing reducing position (FIG. 8), the elevating member 631 contacts the pressing member 60 and raises itself. Hence, the biasing force of the spring 65 acts between the elevating member 631 and the pressing member 60. For this reason, the biasing force of the spring 65 acts only between the elevating member 631 and the pressing member 60 and does not serve as a load for the motor 635. That is, the load applied to the moving mechanism 63 at the pressing reducing position includes only the biasing force of the spring 64 and the weights of the components.

Also, when the pressing member 60 is at the pressing position (FIG. 9), the cam 633 has a phase 180° oppose to that at the pressing reducing position, and the pressing portion 61 of the pressing member 60 contacts the container 200 and presses it downward. The pressing distance of the pressing portion 61, that is, the rotation amount of the pressing member 60 changes depending on the remaining amount in the container 200. In FIG. 9, the pressing members 60 at the four upper stages indicate a mode in which the containers 200 that are full of liquid are pressed. The pressing members 60 at the four lower stages indicate a mode in which the containers 200 that are deflated because of very little remaining amount are pressed. The biasing forces of both the springs 64 and 65 and the weights of the components act on the container 200. Since the springs 64 and 65 are arranged in each storage portion 3, even if the remaining amounts in the containers 200 of the storage portions 3 are different, an optimum pressing force can be applied to each container 200.

At this time, the biasing force of the spring 64 acts on the container 200 but not on the elevating member 631. The biasing force of the spring 65 acts between the container 200 and the elevating member 631 which are in contact with the pressing member 60. The cam 633 acts to move the elevating member 631 downward to the lower side of the container 200. Thus, using the two springs 64 and 65 at different attachment positions and the cam 633 capable of moving both upward and downward, the load applied to the moving mechanism 63 at the time of operation is reduced.

Note that at the pressing position, since the extensions of the springs 64 and 65 are smaller when the container 200 is deflated because of a small remaining amount, the pressing force acting on the container 200 is also small. If the remaining amount in the container 200 is large, the reaction force from the container 200 is readily received at the time of pressing, and a larger pressing force is needed to deeply push in. Reversely, if the remaining amount is small, the reaction force from the container 200 is small. For this reason, even if the pressing force is small, it is possible to deform the container 200 and easily move the liquid inside. In other words, the push-in amount (pressing amount) of the pressing member 60 to push in the container 200 changes in accordance with the remaining amount of the liquid in the container 200. For this reason, the springs 64 and 65 are arranged at positions where the pressing force decreases along with the deflation of the container 200. Hence, the biasing forces of the springs need not be more than necessity. In this embodiment, the load applied to the pressing portion 61 is adjusted to, for example, about 500 gf when the container 200 is full of liquid or about 300 gf when the remaining amount is little.

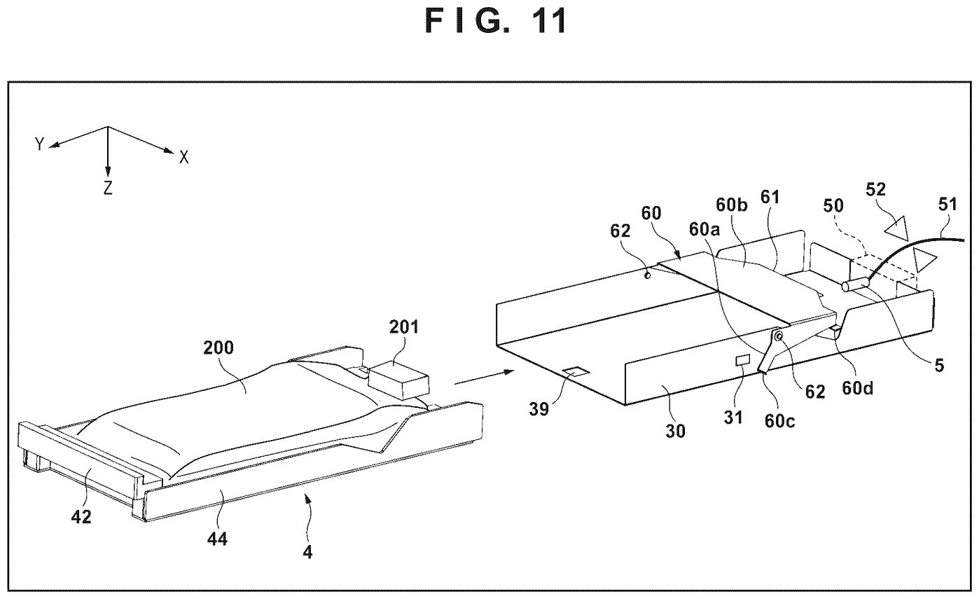

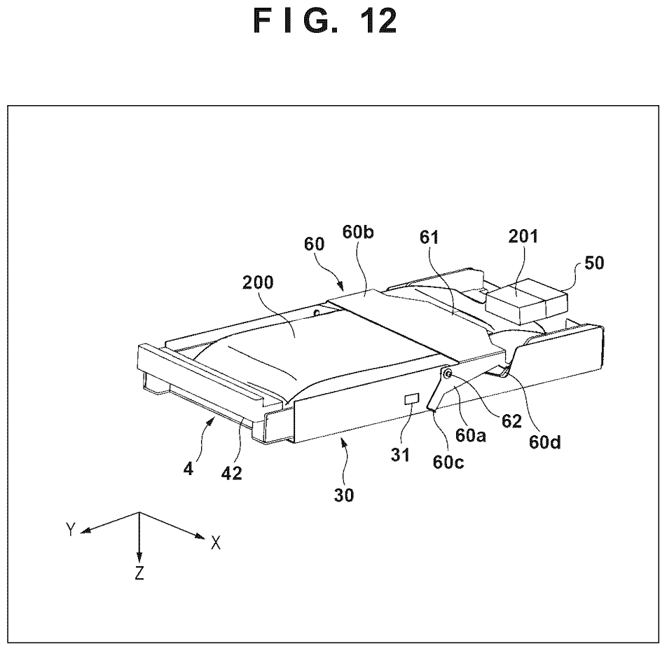

The configuration of the pressing member 60 will be described with reference to FIGS. 11 and 12. FIG. 11 is a perspective view of the case with a stirring function and the support unit in a separated state. FIG. 12 is a perspective view of the case with a stirring function and the support unit in an attached state.

The pressing member 60 includes a pair of side plates 60a located on the side portions of the case 30 in the X direction, and a top plate 60b straddling the case 30 in the X direction and connected between the pair of side plates 60a. On each side plate 60a, the pressing member 60 is rotatably supported by the case 30 via the rotation shaft 62, and the pressing portion 61 is formed at the distal end of the top plate 60b.

A lock portion 60c on which an end portion of the spring 64 is locked, and an abutment portion 60d on which an end portion of the spring 65 is locked and which abuts against the elevating member 631 at the time of rising of the elevating member 631 and causes rotation of the pressing member 60 are formed on each side plate 60a. Both the lock portion 60c and the abutment portion 60d are formed in a form of a projecting piece projecting in the X direction.

A remaining amount detection sensor 31 is provided on a side portion of the case 30. The remaining amount detection sensor 31 is, for example, an optical sensor. The remaining amount detection sensor 31 is a position detection sensor that detects the side plate 60a and thus detects the position of the pressing portion 61, and is also a sensor that detects the remaining amount in the container 200 based on the position detection result. More specifically, as for the detection position of the remaining amount detection sensor 31, it is arranged at a position to detect the side plate 60a when the container 200 deflated because of the decrease of the remaining amount is pressed. This uses the fact that the push-in amount at the time of pressing changes depending on the degree of deflation of the container 200. In this embodiment, since the pressing portion 61 is brought into contact with the container 200, the position of the side plate 60a reflects the remaining amount in the container 200, and therefore, the accuracy of remaining amount detection is high. The detection position of the remaining amount detection sensor 31 is designed such that, for example, the side plate 60a is detected when the container 200 whose remaining amount is about 100 ml is pressed.

The pressing member 60 can be formed by, for example, a plate material made of a metal (steel plate, or the like). As compared to a member of a resin or the like, since the strength is high even if it is thin, the height of the storage portion 3 can be suppressed. The rotation shaft 62 of the pressing member 60 is arranged on the outer side of the container 200 in the X direction, and is provided at a position where the rotation shaft 62 and the container 200 overlap in the X direction when the container 200 is full of liquid. With these contrivances to suppress the size in the Z direction, even if the pressing member 60 is installed in the storage portion 3 of each stage to impart the stirring function, the containers 200 of multiple stages can be stored in a limited space under the housing of the system 100.

Also, the width of the pressing member 60 in the X direction is smaller at the pressing portion 61 than near the rotation shaft 62. Thus, if the pressing portion 61 presses a tank, it is possible to prevent portions other than the pressing portion 61 from contacting the container 200 and prevent the container 200 from being damaged.

When the width of the pressing member 60 in the X direction is made smaller at the pressing portion 61 than near the rotation shaft 62, the following advantage can be obtained. As described above, the gusset portions 202a are provided on the side surfaces of the container 200. The gusset portion 202a includes a welded portion between flexible members, and has higher rigidity as compared to the other portions. To deflate the container 200 by folding the gusset portions 202a inside in accordance with a decrease of the remaining amount, an adequate pressing force is needed. In a state in which the remaining amount in the container 200 is large, the gusset portions 202a are expanded in the upward-downward direction, and the gusset portions 202a are sometimes expanded not inside but outside. To squeeze the gusset portions 202a, an adequate pressing force is needed.

When the pressing portion 61 is arranged inside the gusset portions 202a in the X direction, it is possible to efficiently press and deform the container 200 for stirring. That is, the pressing portion 61 is arranged to press the center side of the container 200 with respect to the gusset portions 202a. The height of the gusset portions 202a is, for example, about 20 mm on both side surfaces. When the pressing portion 61 is located inside the gusset portions 202a on both side surfaces, it hardly receives the reaction force of the gusset portions 202a and can efficiently press the container 200. The pressing efficiency can further be improved by designing the width of the pressing portion 61 in the X direction such that it is fitted, for example, 10 mm or more inside from the gusset portions 202a. This is because when the pressing portion 61 is apart from the gusset portions 202a in the X direction, the influence of the reaction force of the gusset portions 202a is smaller. Note that the width of the pressing portion 61 in the X direction is preferably designed apart from the gusset portions 202a by at least 1 mm, and may be designed apart by, for example, 5 mm or 10 mm.

As a form for minimizing the width of the pressing portion 61 in the X direction, for example, the pressing portion 61 may be in point contact with the container 200. However, in a case where the container 200 is long in the Y direction, as in this embodiment, if the pressing portion 61 is in point contact with the container 200, the fluidity of the liquid in the container 200 may lower. More specifically, if the width of the pressing portion 61 in the X direction is too small, the flow of the liquid corresponding to the push-in amount of the pressed container 200 is dispersed even outside in the X direction, the flow amount of the liquid in the Y direction decreases.

Hence, for example, if the width of the pressing portion 61 in the X direction is set to ⅓ or more the width of the bag 202 of the container 200 in the X direction, the fluidity of the liquid in the Y direction can be improved in the bag 202 at the time of pressing. For example, if the width of the bag 202 in the X direction is 180 mm, the width of the pressing portion 61 in the X direction is set to 60 mm or more, thereby improving the fluidity of the liquid in the Y direction in the bag 202 at the time of pressing.

To summarize, if the width of the bag 202 in the X direction is 180 mm, and the height of the gusset portions 202a is 20 mm, the width of the pressing portion 61 in the X direction is preferably 60 mm to 120 mm and may be particularly 90 mm.

### (Stirring Operation)

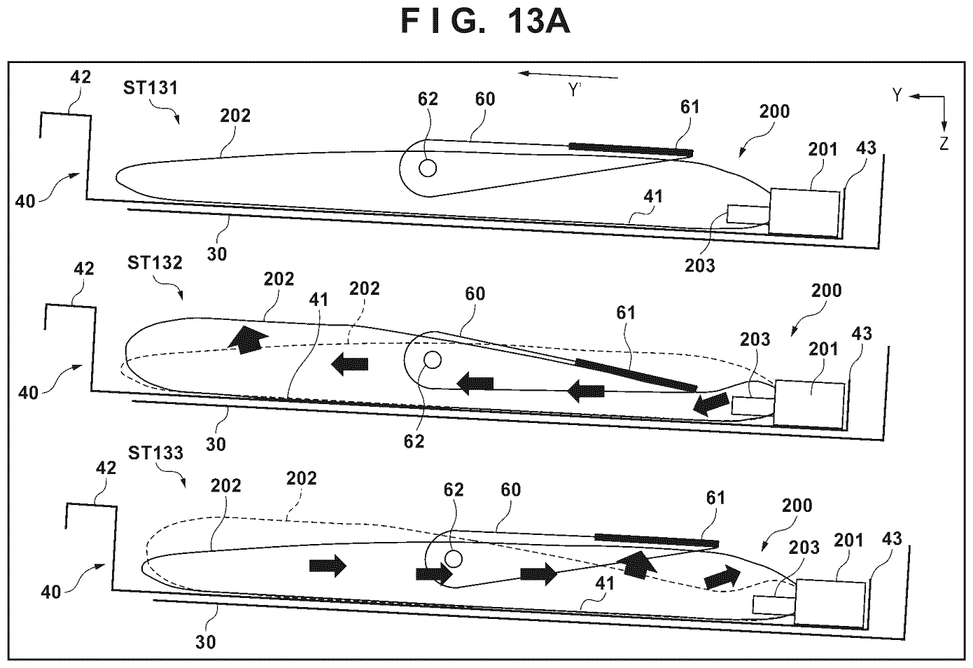

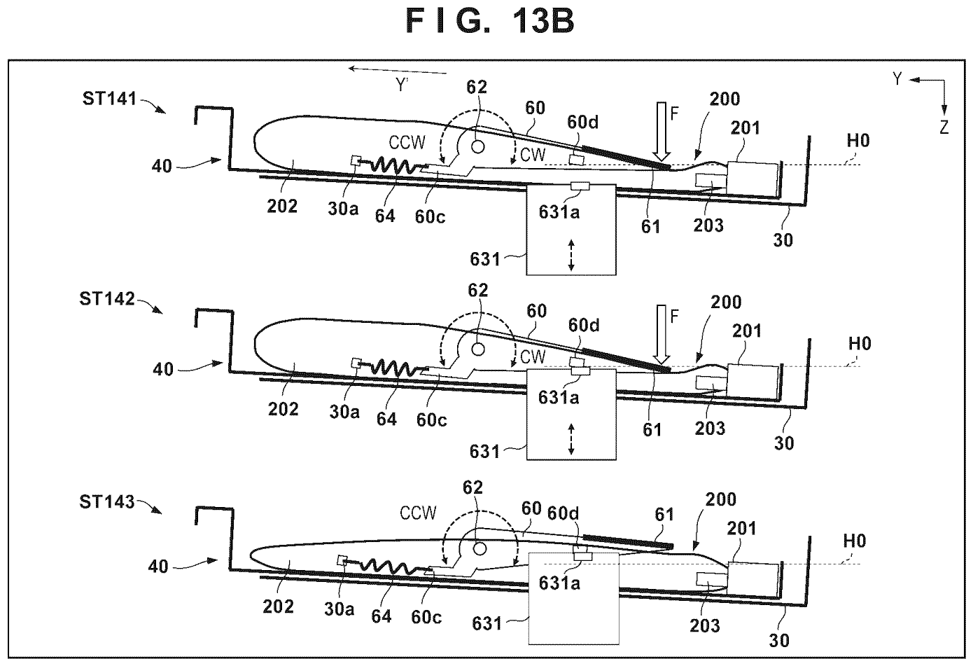

The stirring operation of the liquid in the container 200 by pressing the pressing portion 61 against the container 200 will be described with reference to FIG. 13A. FIG. 13A is an explanatory view of the stirring operation. As shown in FIG. 7, the attachment posture of the support unit 4 is tilted in this embodiment. In FIG. 13A, a direction parallel to the tilt angle direction of the attachment posture is defined as a Y′ direction. In the following explanation, the side of the outlet member 201 of the container 200 will sometimes be referred to as a −Y′ direction, and the opposite side will sometimes be referred to as a +Y′ direction. Note that arrows in FIG. 13A indicate the direction of liquid flow that occurs in the bag 202 of the container 200.

In this embodiment, the stirring operation includes a pressing operation and a pressing reducing operation (or pressing relaxing operation). The pressing portion 61 is arranged facing the placement surface 41 of the support unit 4. The pressing portion 61 is reciprocally moved between the pressing reducing operation and the pressing operation. Thus, the bag 202 is deformed to cause the flow of the liquid inside and stir it.

A state ST131 in FIG. 13A indicates a state in which the pressing portion 61 (and the pressing member 60) is at the pressing reducing position. In this embodiment, at the pressing reducing position, the pressing portion 61 is apart from the placement surface 41 and is located at a height not to contact the bag 202, and does not press the bag 202. Hence, it can also be said that the pressing reducing position is a pressing cancel position.

The moving mechanism 63 is driven from the state ST131 in FIG. 13A, and the pressing operation is performed, as indicated by a state ST132 in FIG. 13A. In the pressing operation, the pressing member 60 rotates, the pressing portion 61 moves to a position where it is closer to the placement surface 41 than at the pressing reducing position, and the pressing portion 61 presses the bag 202 to the side of the placement surface 41. Thus, the bag 202 is deformed, and the liquid inside is flowed and stirred.

In this embodiment, the container 200 is attached in a tilting posture to the storage portion 3 while directing the outlet member 201 to the lower side in the Z direction. Hence, at the stage of the state ST131 in FIG. 13A, the liquid in the container 200 is readily distributed while being localized on the side of the outlet member 201 by the weight of its own, and the bag 202 expands more on the side of the outlet member 201 than at the center portion in the Y′ direction. The pressing portion 61 is designed to press the side of the end portion 43 provided with the outlet member 201 out of the end portions 42 and 43 of the container 200. Since the pressing portion 61 presses the expanded portion of the bag 202 or a portion close to it, the flow of the liquid in the bag 202 can be promoted. The portion that the pressing portion 61 presses may be the most expanded portion of the bag 202.

Note that if the tilt angle is too large, the localization of the liquid in the container 200 is large, and the reaction force by the weight of the gathered liquid increases. As a result, when pressing by the pressing member 60, the load applied to the pressing member 60 increases. For this reason, as described above, the tilt angle is preferably set to less than 45° and particularly preferably 10° or less. The tilt angle in this embodiment is set to 3°. The tilt angle may be set in accordance with the liquid amount storable in the container 200. For example, if the liquid amount is small, the tilt angle may be set large as compared to a case where the liquid amount is large.

Since the pressing portion 61 presses the bag 202 on the side of the outlet member 201, stirring can effectively be performed when the liquid flows to the opposite side. The rotation shaft 62 of the pressing member 60 is located on the opposite side of the outlet member 201 in the Y′ direction of the container 200 when viewed from the pressing portion 61. In the pressing operation, the rotation direction of the pressing member 60 is the clockwise direction in the state ST132 shown in FIG. 13A. That is, the pressing member 60 rotates clockwise about the rotation shaft 62 as the rotation center. When the rotation direction is thus set, a vector in the +Y′ direction is generated, and the liquid can readily be flowed in the +Y′ direction. That is, the liquid readily flows, in the bag 202, to the opposite side of the outlet member 201.

As described above, in this embodiment, the pressing portion 61 is designed to press the side of the end portion 43 provided with the outlet member 201 out of the end portions 42 and 43 of the container 200. A portion of the bag 202 near the intake port 203 of the container 200 is pressed, and stirring of the liquid around there is particularly promoted. In printing, the liquid in the container 200 flows out from a region close to the intake port 203 to the tube 51. By pressing the portion near the intake port 203 and stirring the liquid, the liquid whose concentration is more even can be sent to the tube 51.

The moving mechanism 63 is driven from the state ST132 in FIG. 13A, and the pressing reducing operation is performed, as indicated by a state ST133 in FIG. 13A. In the pressing reducing operation, the pressing member 60 rotates, and the pressing portion 61 returns from the pressing position to the pressing reducing position. That is, the pressing member 60 rotates counterclockwise about the rotation shaft 62 as the rotation center in the state ST133 in FIG. 13A. That is, when transiting from the state ST132 in FIG. 13A to the state ST133 in FIG. 13A, the pressing member 60 reverses the rotation direction. When pressing by the pressing member 60 is reduced, the bag 202 is going to restore its original shape while the liquid in the bag 202 flows. After that, the pressing operation can be performed again.

The pressing operation and the pressing reducing operation are repetitively performed, thereby stirring the liquid in the bag 202. That is, when the pressing portion 61 is at the pressing position, as indicated by the state ST132 in FIG. 13A, the portion of the container 200 near the pressing portion 61 is recessed, the liquid flows in the +Y′ direction, and the opposite side of the outlet member 201 of the container 200 is expanded. After that, when pressing is reduced, as in the state ST133 shown in FIG. 13A, the ink flowed by the pressing flows in the −Y′ direction by the weight of its own. By repeating the pressing operation and the pressing reducing operation, the liquid is reciprocally moved in the Y′ direction in the bag 202 and stirred. The flow of the liquid caused by the pressing reducing operation uses the weight of the liquid. When the weight of the liquid is used, the mechanism necessary for stirring the liquid can have a simple configuration.

The operations of the pressing member 60 and the moving mechanism 63 in the series of pressing operations shown in FIG. 13A will be described with reference to FIG. 13B. The pressing member 60 rotates about the rotation shaft 62, and the pressing portion 61 is set in the pressing state by rotation in the CW direction and set in the pressing reducing state by rotation in the CCW direction.

The action of the spring 64 will be described. The lock portion 60c is formed on the pressing member 60, and a lock portion 30a is formed on the case 30. The spring 64 is provided between the lock portions 60c and 30a. By the tensile force of the spring 64, the pressing member 60 is biased to rotate in the CW direction, and the pressing portion 61 is set in the pressing state.

The elevating member 631 is provided with an abutment portion 631a. As indicated by a state ST142 in FIG. 13B, when the elevating member 631 moves upward, the abutment portion 631a of the elevating member 631 abuts against the abutment portion 60d of the pressing member 60. This position is defined as an abutment reference height HO. As indicated by a state ST143 in FIG. 13B, when the elevating member 631 further moves upward, the pressing member 60 rotates about the rotation shaft 62 in the CCW direction, and the pressing portion 61 is set in the pressing reducing state.

Reversely, when the elevating member 631 moves downward, the abutment portion 631a of the elevating member 631 is separated from the abutment portion 60d of the pressing member 60. By the tensile force of the spring 64, the pressing member 60 is biased to rotate in the CW direction, and the pressing portion 61 is set in the pressing state again. In this way, the pressing member 60 rotates between the pressing position and the pressing reducing position by the elevating motion of the elevating member 631.

In a state ST141 shown in FIG. 13B, rotation of the pressing member 60 stops at a position where a pressing load F of the pressing portion 61 by the spring 64 balances the reaction force of the container 200. For this reason, if the remaining amount of the liquid in the container 200 decreases, the position (pressing position) where the forces balance lowers accordingly. Since the pressing height of the pressing member 60 changes depending on the remaining amount of the liquid in the container 200, it is possible to press the container 200 and stir the liquid, following the remaining amount of the liquid in the container 200.

Next, when repeating the stirring operation, liquid stirring performance can be adjusted by the period. In the pressing reducing operation, the liquid in the bag 202 flows a little later after the rotation of the pressing member 60. In the pressing reducing operation, the higher the fluidity of the liquid is, the higher the stirring effect is. Also, if the pressing operation is performed after the liquid sufficiently flows, the liquid storage amount of the bag 202 becomes large near the pressing portion 61, and the bag 202 expands. Hence, by pressing there, the stirring performance can further be improved. The period of the stirring operation is, for example, a period longer than several Hz and, particularly, a period longer than 1 Hz. If the period of the stirring operation is too long, the total time of the stirring operation increases, and the power consumption of the motor 635 may increase. Hence, the period of the stirring operation may be set in the range of, for example, 0.5 to 0.7 Hz and, particularly, to 0.6 Hz. That is, a configuration in which the series of operations shown in FIG. 13A is performed at a period of, for example, about 1.6 to 1.7 sec.

In addition, when the remaining amount decrease, and the container 200 is deflated, the ink on the upper side (+Y′ side) of the tilting container 200 flows by the weight of its own to the −Y′ side, and the storage amount in this portion decreases. To the contrary, the liquid stays on the lower side (−Y′ side). In this state, the flow distance of the liquid in the +Y′ direction at the time of the pressing operation is short, and the time of return of the liquid in the pressing reducing operation is also short. Hence, the period of the stirring operation may be shortened in accordance with the decrease of the remaining amount in the container 200.

In the stirring operation, the pressing operation and the pressing reducing operation may be repeated while providing a time interval between the pressing reducing operation and the next pressing operation. It is possible to ensure a long flow time of the liquid in the bag 202 from the pressing reducing operation to the start of the next pressing operation and further promote the flow of the liquid by the weight of its own. For example, when the operation is stopped for 0.1 to 0.5 sec in the state ST132 shown in FIG. 13A and the state ST133 shown in FIG. 13A, it is possible to promote the flow of the liquid and improve the stirring efficiency. The time of stop is appropriately set in accordance with the liquid amount storable in the bag 202.

There are several methods for adjusting the period of the stirring operation. First, there is a method using a dwell angle that is a range where the cam follower 637 in contact with the inner cam surface 633e or the outer cam surface 633d is not displaced even if the cam 633 rotates. For example, the dwell angle at a position where the cam follower 637 is at the highest point is set to 40°, and the dwell angle at the lowest point is also set to 40°. In particular, when a dwell angle of 40° is ensured at the highest point, the pressing reducing position can be maintained.

Also, an index angle that is an angle range for raising or lowering the cam follower 637 may largely be set to 140°. As effects, this decreases the load at the time of rotation of the cam 633, and the connected pressing member 60 is slowly transitioned from the pressing state to the pressing reducing position, thereby ensuring time to move ink to the vicinity of the pressing portion 61. These make it possible to sufficiently move the ink at the time of pressing cancel and enhance the stirring effect.

As another method, the motor 635 is temporarily stopped at the pressing reducing position. If time corresponding to the dwell angle of 40° is implemented by motor stop, the dwell angle can be made smaller. Hence, the index angle can be made larger, and the load at the time of cam rotation can further be reduced.

The stirring period to repetitively perform the stirring operation may be set based on time or based on the operation count. For example, several tens of minutes may be defined as one set, and the stirring operation may repetitively be performed only one set a day. Alternatively, for example, several tens of times may be defined as one set, and the stirring operation may repetitively be performed only one set a day. The necessary stirring period or execution timing may be set in consideration of the sedimentation speed of the color material in the liquid.

Referring to FIG. 7, the container 200 and the support unit 4 are attached to the storage portion 3, and these are tilted with respect to the horizontal plane, as described above. From the viewpoint of the liquid stirring effect, it is advantageous that the tilt angle is smaller than 45°, and it is more advantageous that the tilt angle is, for example, smaller than 20°, particularly, 10° or less. In the example shown in FIG. 7, the tilt angle is assumed to be 3°.

Stirring by pressing is possible even if the tilt angle is close to 90°, but the weight of the ink acts in the direction of resisting the flow of the liquid by pressing. Hence, a larger pressing force is needed to make the liquid sufficiently flow. If the tilt angle is less than 45°, the vector of the flow of the liquid toward the −Y direction is relatively small because of the weight of the liquid. As for the expansion amount of the portion of the bag 202 on the −Y side at the time of pressing operation, if the tilt angle is 10° or less, a large expansion amount can be obtained by a smaller pressing force. If the expansion amount of the bag 202 at the time of pressing is large, the flow amount of the liquid inside is large. That is, the efficiency of pressing is high.

Note that in this embodiment, at the pressing reducing position, the pressing portion 61 is located at a height not to contact the bag 202. However, the pressing portion 61 may contact the bag 202, and the pressing portion 61 may be located at a position to press the bag 202 with a pressing amount smaller than that at the pressing position. In such a slightly push-in state at the pressing reducing position, the upper limit position of the pressing member 60 in the Z direction can be suppressed low, and the size of the liquid storage apparatus 1 in the Z direction can be reduced.

### (Regulating Operation)

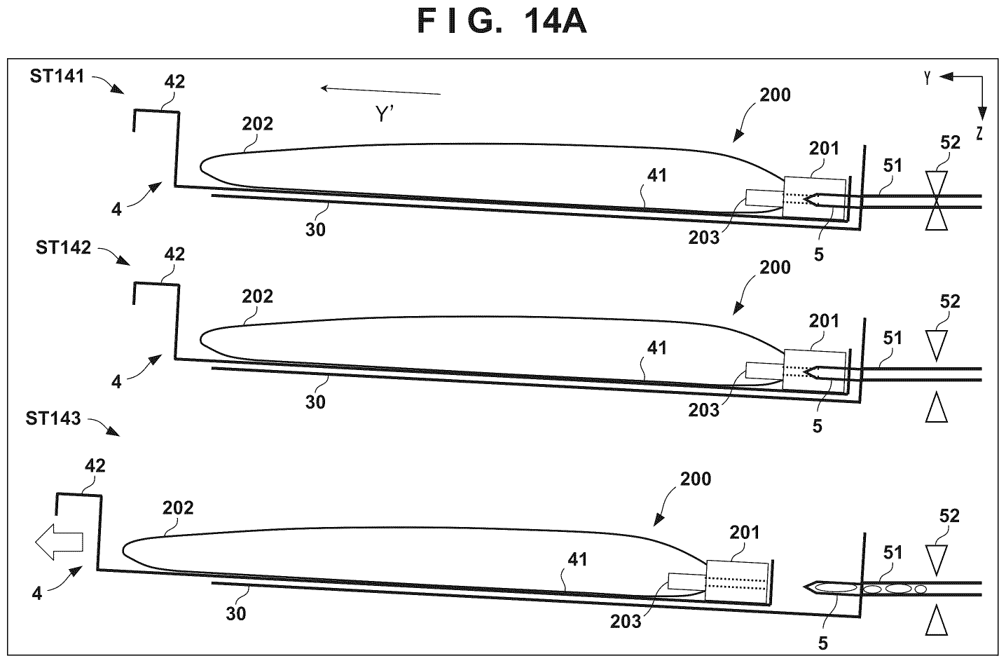

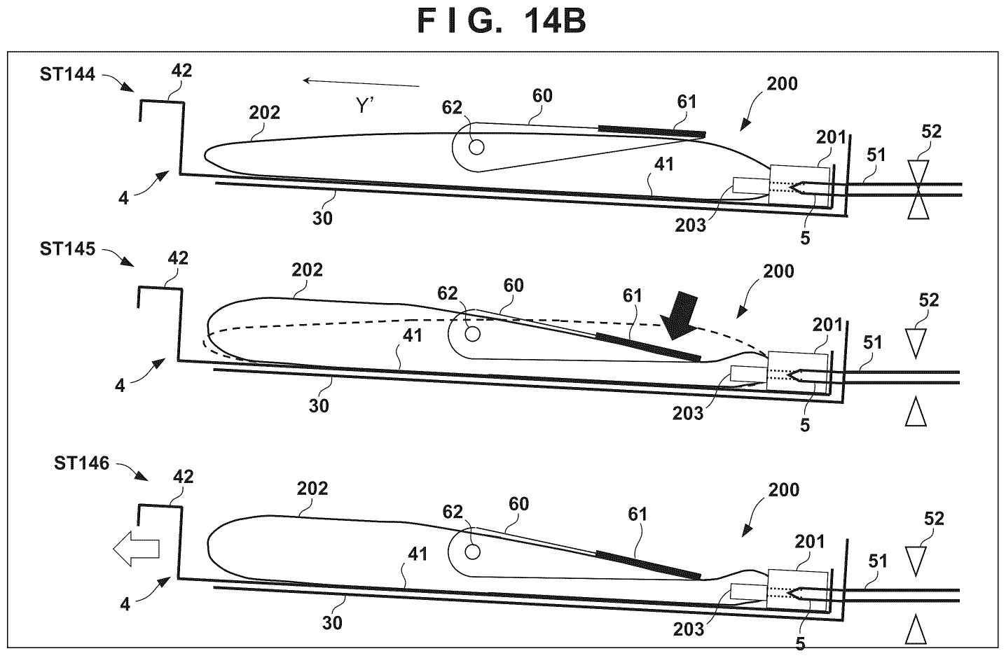

In a configuration in which the container 200 can detachably be attached, as in this embodiment, the container 200 may be detached by the user at an inappropriate timing, as in a case where the liquid is being supplied from the container 200 to the discharge head 108. If the container 200 is detached at an inappropriate timing, air may enter from the path forming member 5 to the tube 51. In addition, the liquid may leak to the storage portion 3 and make the storage portion 3 dirty. FIG. 14A is an explanatory view showing an example.

A state ST141 indicates a state in which the ink in the container 200 is not supplied to the liquid discharge apparatus 101. The passage valve 52 is closed. A state ST142 indicates a state in which the passage valve 52 is opened, and the ink in the container 200 is supplied to the liquid discharge apparatus 101. The internal state of the path forming member 5 is a negative pressure state, and the ink in the container 200 is sucked out to the path forming member 5 and thus flows out.

A state ST143 indicates a state in which the support unit 4 is pulled out of the storage portion 3 in the state ST142. The distal end of the path forming member 5 is exposed, and air is sucked in from there. The air that has entered moves to the discharge head 108 upon a cleaning operation or along with the progress of discharge and causes a discharge failure. Also, when the support unit 4 is pulled out, the ink scatters from the path forming member 5 and sticks to the case 30 or the outlet member 201 and makes these dirty.

In this embodiment, the pressing unit 6 is used to prevent the container 200 from being detached at an inappropriate timing. The pressing unit 6 is used not only to stir the liquid but also to regulate detachment of the container 200, thereby simplifying the structure and decreasing the number of parts.

FIG. 14B is a view showing an example of the regulating operation by the pressing unit 6. A state ST144 indicates a state in which the pressing member 60 is located at the pressing reducing position, and the passage valve 52 is closed. When opening the passage valve 52, the pressing member 60 is moved to a regulating position, as indicated by a state ST145. The pressing portion 61 presses the container 200, and this state is maintained. In this embodiment, the regulating position is the same position as the pressing position.

A state ST146 indicates a state in which the support unit 4 is about to be pulled out of the storage portion 3 in the state ST145. Since a force to resist pull-out of the support unit 4 acts due to pressing of the pressing member 60, the support unit 4 is prevented from being pulled out of the storage portion 3 by the user. Detachment of the container 200 is thus prevented.

Note that although the regulating position is the same as the pressing position in this embodiment but may be different. For example, the regulating position may be a position where the pressing portion 61 is closer to the placement surface 41 than at the pressing position. Reversely, the regulating position may be a position where the pressing portion 61 is farther from the placement surface 41 than at the pressing position. Concerning the regulating position, the distance to the placement surface 41 may change depending on the remaining amount of ink in the container 200. If the remaining amount is large, the position may be apart from the placement surface 41, and if the remaining amount is small, the position may be close to the placement surface 41.

### <Control Circuit>

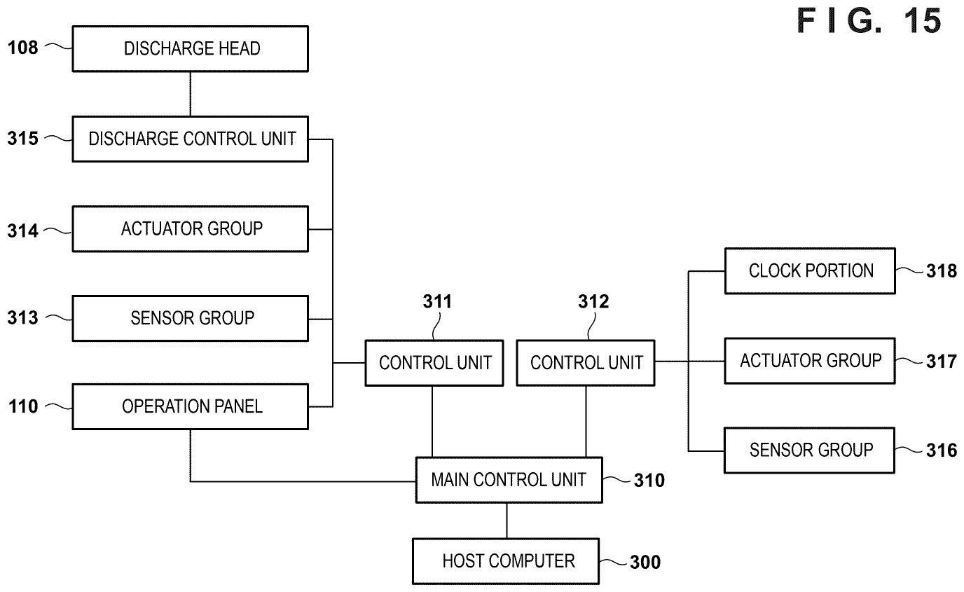

The configuration of the control circuit of the system 100 will be described with reference to FIG. 15. FIG. 15 is a block diagram of the control circuit of the system 100. A main control unit 310 controls the entire system 100 in accordance with an instruction from a host computer 300 or the operation panel 110. A control unit 311 controls the liquid discharge apparatus 101 based on an instruction of the main control unit 310, and a control unit 312 controls the liquid storage apparatus 1 based on an instruction of the main control unit 310. The main control unit 310 and the control units 311 and 312 each include, for example, at least one processor, at least one storage device, and at least one input/output interface. The storage device is, for example, a semiconductor memory such as a RAM or a ROM. The input/output interface performs input/output of signals between the processor and an external device (a sensor, a motor, or the like).

A discharge control unit 315 performs control of the discharge head 108, particularly, discharge control of the liquid. An actuator group 314 includes a conveyance motor that is the driving source of the conveyance unit 106, a carriage motor that is the driving source of the moving mechanism of a carriage (not shown), a winding motor that is the driving source of the winding unit 105, and a recovery motor that is the driving source of the recovery unit 109. The actuator group 314 further includes a cutter motor that is the driving source of a cutter (not shown) configured to cut the print medium M after image printing. A sensor group 313 includes various kinds of sensors provided in the liquid discharge apparatus 101.

A clock portion 318 is a counter that outputs a count result of an elapsed time to the control unit 312. If a liquid stirring period is managed by time, the count result of the clock portion 318 can be used. Also, the stirring timing can be decided using the count result of the clock portion 318.

An actuator group 317 includes the motor 635 provided in the liquid storage apparatus 1, a pump motor that supplies the liquid in the tube 51 to the liquid discharge apparatus 101, the passage valve 52, and the like. When the pump motor is driven in the open state of the passage valve 52, the liquid is sucked out from the container 200 and supplied to the liquid discharge apparatus 101. A sensor group 316 includes the sensors 31 and 38 provided in the liquid storage apparatus 1. Driving of the state indicator 21 is also controlled by the control unit 312.

### <Example of Processing of Control Circuit>

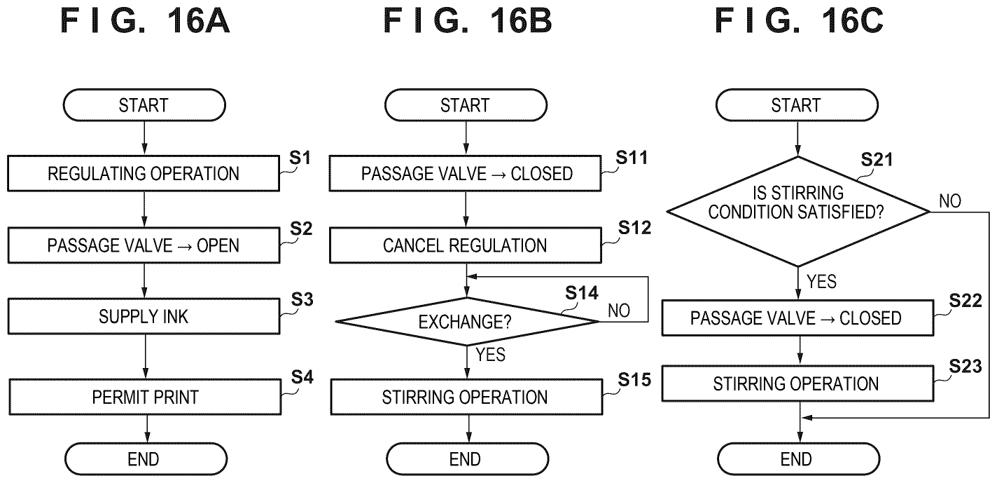

An example of processing executed by the control unit 312 will be described concerning control examples of the regulating operation and the stirring operation by the pressing unit 6. FIG. 16A shows an example of processing in a case where a discharge operation is performed by the liquid discharge apparatus 101, and shows an operation at the start of supply of the ink in the container 200.

In step S1, the pressing unit 6 is caused to perform the regulating operation. The pressing portion 61 is located at the regulating position. In step S2, the passage valve 52 is opened. Thus, a path from the container 200 to the discharge head 108 communicates. In step S3, the pump motor is driven to start liquid supply from the container 200 to the discharge head 108. In step S4, a print permission instruction is transmitted to the main control unit 310. Thus, printing is started in the liquid discharge apparatus 101. During discharge of the liquid from the discharge head 108, a state in which the pressing portion 61 presses the container 200 is maintained, and the support unit 4 is prevented from being pulled out of the storage portion 3.

Next, FIG. 16B shows an example of processing concerning exchange of the container 200, and shows an example of processing executed in a case where the remaining amount in the container 200 decreases, and the user is urged to exchange it. The liquid discharge apparatus 101 urges the user to exchange the container 200 via, for example, the operation panel 110. If an instruction to execute exchange of the container 200 by the user is input from the operation panel 110, processing shown in FIG. 16B is started. Note that a notification of the user or input of an instruction from the user may be done not only via the operation panel 110 but also via the host computer 300 or voice.

In step S11, the passage valve 52 is closed. In step S12, regulation is canceled by the pressing unit 6. Here, the pressing portion 61 is moved from the regulating position to the pressing reducing position. In step S14, it is determined whether the container 200 is exchanged. As for whether the container 200 is exchanged, for example, if the detection result of the sensor 38 of the storage portion 3 indicates a change from unlock to lock, it can be determined that the container 200 is exchanged. In step S15, the pressing unit 6 performs the stirring operation. In this embodiment, the stirring operation is performed in a state in which the passage valve 52 is closed. Even if sedimentation of the color material progresses in the container 200 after exchange, the liquid can be made even by the stirring operation. The stirring operation is performed until a predetermined condition is satisfied, for example, a predetermined time elapses, or the reciprocal movement count of the pressing member 60 reaches a predetermined count.

Next, FIG. 16C shows an example of processing in which the stirring operation by the pressing unit 6 is performed at a timing other than the time of exchange of the container 200.

In step S21, it is determined whether a stirring start condition is satisfied. If the stirring start condition is satisfied, the process advances to step S22. The stirring start condition is, for example, arrival of a predetermined time of a day. Alternatively, the stirring start condition may be that the time elapsed from the end of the preceding stirring operation reaches a predetermined time. Alternatively, the stirring start condition may be that the user instructs stirring via the operation panel 110 or the like.

In step S22, the passage valve 52 is closed. In step S23, the stirring operation is performed by the pressing unit 6. In this embodiment, the stirring operation is performed in a state in which the passage valve 52 is closed. The liquid in the container 200 can be made even. The stirring operation is performed until a predetermined condition is satisfied, for example, a predetermined time elapses, or the reciprocal movement count of the pressing member 60 reaches a predetermined count.

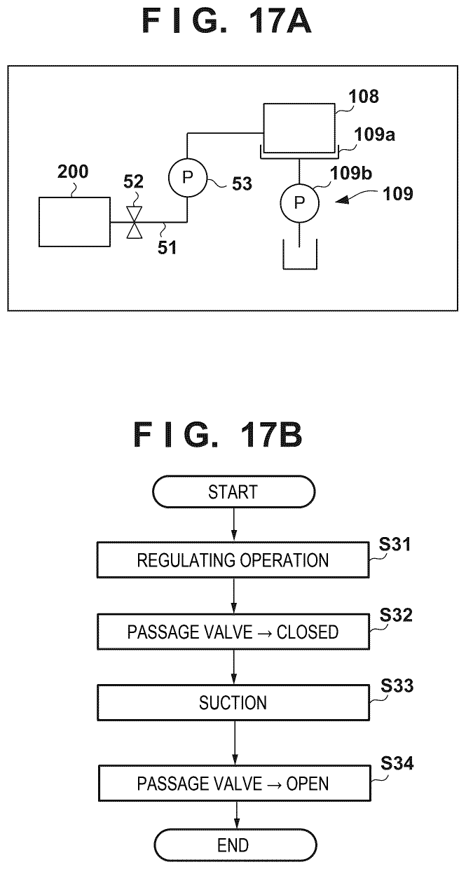

An example in which the regulating operation is performed in a state in which the passage valve 52 is closed will be described next. In this embodiment, the regulating operation is sometimes performed at the time of maintenance of the discharge head 108. FIG. 17A shows an example of the configuration of the recovery unit 109. The recovery unit 109 includes a cap 109a that covers the discharge surface of the discharge head 108, and a pump 109b that sucks inside of the cap 109a. A pump 53 is a pump that supplies the liquid in the tube 51 to the liquid discharge apparatus 101 and is driven by the pump motor described above.

FIG. 17B shows an example of processing at the time of maintenance of the discharge head 108. In step S31, the pressing unit 6 is caused to perform the regulating operation. The pressing portion 61 is located at the regulating position. In step S32, the passage valve 52 is closed. In step S33, under the control of the control unit 311, the pump 109b is driven in a state in which the cap 109a covers the discharge surface of the discharge head 108. By driving the pump 109b, a viscous substance or the like in the discharge head 108 is discharged to the cap 109a, and the path in the discharge head 108 and the tube 51 is set in a negative pressure state.

In step S34, the passage valve 52 is opened. Thus, a path from the container 200 to the discharge head 108 communicates. The liquid is sucked from the container 200 to the path in the discharge head 108 and the tube 51 in the negative pressure state and discharged to the cap 109a. The path in the discharge head 108 and the tube 51 is cleaned.

During the maintenance, a state in which the pressing portion 61 presses the container 200 is maintained, and the support unit 4 is prevented from being pulled out of the storage portion 3. In this example, even if the passage valve 52 is closed, the state in which the pressing portion 61 presses the container 200 is maintained, and the support unit 4 is prevented from being pulled out of the storage portion 3. If the support unit 4 is pulled out of the storage portion 3 and let stand in a case where the passage valve 52 is closed, the liquid adhering to the distal end of the path forming member 5 may contact air, dry, and stick. This sticking can be a factor to close the path forming member 5. In this example, even if the passage valve 52 is closed, the support unit 4 is prevented from being pulled out of the storage portion 3, and the sticking can be prevented.

### Second Embodiment

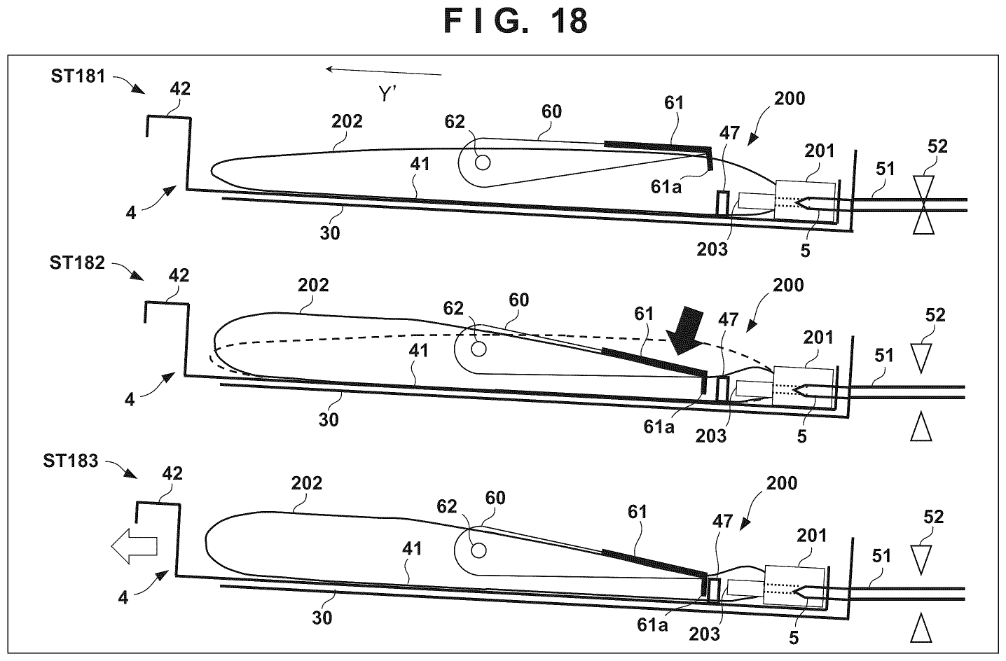

A structure that more powerfully prevents a support unit 4 from being pulled out of a storage portion 3 may be provided. FIG. 18 is an operation explanatory view showing an example. The support unit 4 includes a projecting portion 47 projecting upward from a placement surface 41, and a pressing portion 61 includes a distal end portion 61a bent to the side of the placement surface 41.

A state ST181 indicates a state in which a pressing member 60 is located at the pressing reducing position, and a passage valve 52 is closed. When opening the passage valve 52, the pressing member 60 is moved to the regulating position, as indicated by a state ST182. The pressing portion 61 presses a container 200, and this state is maintained. The distal end portion 61a of the pressing portion 61 is located at a position overlapping the projecting portion 47 in the displacement direction (Y′ direction) of the support unit 4 from the storage position to the extraction position. In other words, the distal end portion 61a is located on the locus of the projecting portion 47 when the support unit 4 is pulled out.

A state ST183 indicates a state in which the support unit 4 is about to be pulled out of the storage portion 3 in the state ST182. The pressing portion 61 presses the container 200, additionally, the projecting portion 47 faces the distal end portion 61a across a bag 202 of the container 200, and the distal end portion 61a resists the displacement of the support unit 4. Detachment of the container 200 is thus prevented.

### Third Embodiment

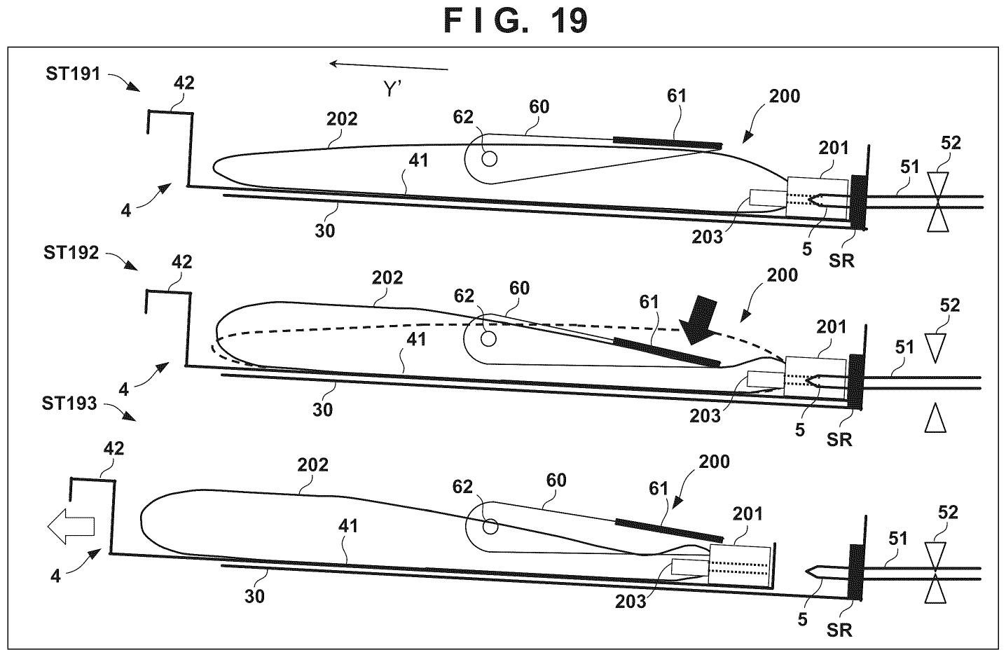

Opening/closing of a passage valve 52 may be controlled depending on whether a support unit 4 is located at the storage position. FIG. 19 is an operation explanatory view showing an example.

In the example shown in FIG. 19, a position detection sensor SR is provided in each storage portion 3. The position detection sensor SR is, for example, an optical sensor or a mechanical sensor and detects, in the corresponding storage portion 3, whether the support unit 4 is located in the storage portion 3. The passage valve 52 is opened/closed in accordance with the detection result of the position detection sensor SR.

A state ST191 indicates a state in which the support unit 4 is located at the storage position, a pressing member 60 is located at the pressing reducing position, and the passage valve 52 is closed. When opening the passage valve 52, the pressing member 60 is moved to the regulating position, as indicated by a state ST192. A pressing portion 61 presses a container 200, and this state is maintained.

A state ST193 indicates a state in which the support unit 4 is displaced to the extraction position. The position detection sensor SR detects that the support unit 4 is to located at the storage position, and the passage valve 52 that is open is closed. When the user is going to extract the support unit 4, regulation of displacement of the support unit 4 by the pressing portion 61 can cause him/her to take time for extraction, as compared to a case where no regulation exists. Before a path forming member 5 is completely removed from a supply port 201a of an outlet member 201, the extraction is detected by the position detection sensor SR, and the passage valve 52 is closed, thereby preventing air from entering the path forming member 5 or a tube 51.

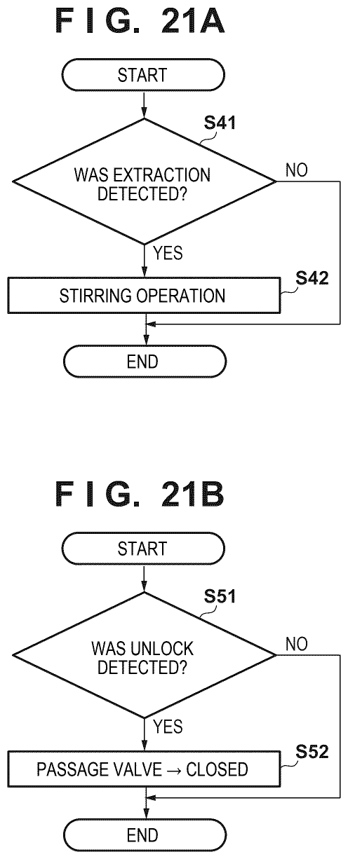

FIG. 21A is a flowchart showing an example of processing executed by a control unit 312 in this embodiment and showing an example of control of the passage valve 52 executed in a state in which the passage valve 52 is open. In step S41, the detection result of the position detection sensor SR is acquired, and it is determined whether extraction of the support unit 4 is detected. Upon determining that the extraction is detected, the process advances to step S42, and the passage valve 52 is closed.

### Fourth Embodiment

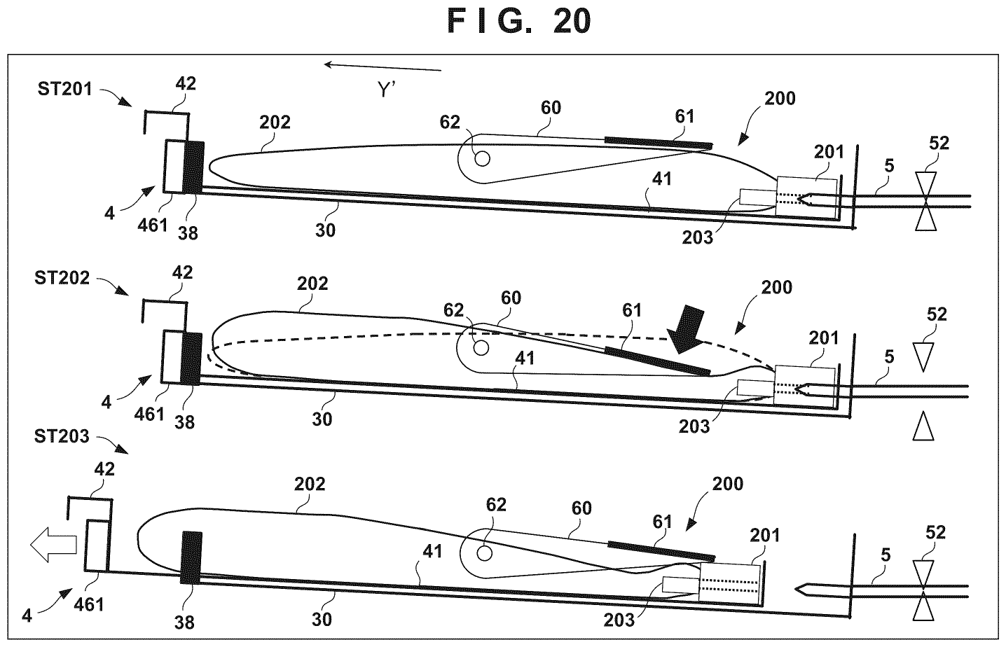

Opening/closing of a passage valve 52 may be controlled in accordance with the state of a lock mechanism 46. FIG. 20 is an operation explanatory view showing an example. In the first embodiment, a sensor 38 that detects the state of the lock mechanism 46 is provided. In this embodiment, the passage valve 52 is opened/closed in accordance with the detection result of the sensor 38.

A state ST201 indicates a state in which a support unit 4 is located at the storage position, a pressing member 60 is located at the pressing reducing position, and the passage valve 52 is closed. A slide member 461 of the lock mechanism 46 is located at the lock position, and the detection result of the sensor 38 indicates a locked state. When opening the passage valve 52, the pressing member 60 is moved to the regulating position, as indicated by a state ST202. A pressing portion 61 presses a container 200, and this state is maintained.

A state ST203 indicates a state in which the slide member 461 of the lock mechanism 46 is moved to the unlock position, and the support unit 4 is displaced to the extraction position. The sensor 38 detects that the lock mechanism 46 is in an unlocked state, and the passage valve 52 that is open is closed. When the user is going to extract the support unit 4, regulation of displacement of the support unit 4 by the pressing portion 61 can cause him/her to take time for extraction, as compared to a case where no regulation exists. If the lock mechanism 46 is in the unlocked state, it is estimated that the support unit 4 is to be detached, and the passage valve 52 is closed. Before a path forming member 5 is completely removed from a supply port 201a of an outlet member 201, the passage valve 52 is closed, thereby preventing air from entering the path forming member 5 or a tube 51.

FIG. 21B is a flowchart showing an example of processing executed by a control unit 312 in this embodiment and showing an example of control of the passage valve 52 executed in a state in which the passage valve 52 is open. In step S51, the detection result of the sensor 38 is acquired, and it is determined, concerning the lock mechanism 46, whether the unlocked state is detected. Upon determining that the unlocked state is detected, the process advances to step S52, and the passage valve 52 is closed.

### Fifth Embodiment

In the first embodiment, the moving mechanism 63 is shared by all pressing members 60. However, while sharing the moving mechanism 63, a mechanism configured to switch transmission/block of the driving force to each pressing member 60 may be provided for each pressing member 60, and the pressing members 60 may individually be rotated. Alternatively, an independent moving mechanism may be provided for each pressing member 60, and each pressing member 60 may independently be rotated. Also, the motion of the pressing member 60 in the stirring operation may be not a rotating motion but a translating motion.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-091596, filed Jun. 5, 2024, which is hereby incorporated by reference herein in its entirety.

What is claimed is:

1. A liquid storage apparatus comprising:
a storage unit configured to extractably store a liquid container with flexibility;
a path forming unit connected to the liquid container stored in the storage unit and configured to form a path configured to flow a liquid out of the liquid container; and
a pressing unit configured to press the liquid container stored in the storage unit,
wherein the pressing unit is configured to perform:
a stirring operation of stirring the liquid stored in the liquid container by repeating pressing of the liquid container and reducing of the pressing; and
a regulating operation of maintaining a state in which the liquid container is pressed and regulating extraction of the liquid container from the storage unit.

2. The apparatus according to claim 1, further comprising a valve configured to open/close the path.

3. The apparatus according to claim 2, wherein
the regulating operation is performed in a case where the valve is open.

4. The apparatus according to claim 2, wherein
the regulating operation is performed in a case where the valve is closed.

5. The apparatus according to claim 2, further comprising a support unit configured to support the liquid container,
wherein the support unit is configured to be displaced between a storage position where the liquid container supported by the support unit is stored in the storage unit and an extraction position where the liquid container supported by the support unit is exposed to outside of the storage unit, and
the path forming unit is connected to the liquid container when the support unit is located at the storage position.

6. The apparatus according to claim 5, further comprising a regulating unit configured to regulate displacement of the support unit from the storage position to the extraction position.

7. The apparatus according to claim 5, further comprising a position detection unit configured to detect whether the support unit is located at the storage position,
wherein the valve is opened/closed in accordance with a detection result of the position detection unit.

8. The apparatus according to claim 5, further comprising:
a lock unit configured to perform lock and unlock of the support unit for the storage position; and
a state detection unit configured to detect a state of the lock unit,
wherein the valve is opened/closed in accordance with a detection result of the state detection unit.

9. The apparatus according to claim 5, wherein
the support unit includes a placement surface on which the liquid container is placed,
the pressing unit includes:
a pressing portion arranged facing the placement surface; and
a moving mechanism configured to move the pressing portion, and
in the regulating operation, the pressing portion presses the liquid container to a side of the placement surface.

10. The apparatus according to claim 9, wherein
the support unit includes a projecting portion projecting from the placement surface, and
in the regulating operation, the pressing portion is located at a position overlapping the projecting portion in a displacement direction of the support unit from the storage position to the extraction position.

11. The apparatus according to claim 9, wherein
the pressing unit comprises a pressing member provided with the pressing portion and supported to be rotatable about an axis crossing a moving direction of the pressing portion, and
the moving mechanism is a mechanism configured to rotate the pressing member.

12. The apparatus according to claim 9, wherein
the stirring operation is an operation of repetitively moving the pressing portion between a first position and a second position,
the first position is a position where the liquid container is pressed to the side of the placement surface, and
the second position is a position farther from the placement surface than at the first position.

13. The apparatus according to claim 2, wherein
the stirring operation is performed in a case where the valve is closed.

14. The apparatus according to claim 1, wherein
a supply destination of the liquid is a liquid discharge apparatus for discharging the liquid to a medium.

15. A control method of a liquid storage apparatus including a storage unit configured to extractably store a liquid container with flexibility, a path forming unit connected to the liquid container stored in the storage unit and configured to form a path configured to flow a liquid out of the liquid container, and a pressing unit configured to press the liquid container stored in the storage unit, the method comprising:
stirring the liquid stored in the liquid container by repeating pressing of the liquid container and reducing of the pressing by the pressing unit; and
maintaining a state in which the liquid container is pressed and regulating extraction of the liquid container from the storage unit by the pressing unit.

16. A system comprising a liquid discharge apparatus for discharging a liquid to a medium, and a liquid storage apparatus,
wherein the liquid storage apparatus comprises
a storage unit configured to extractably store a liquid container with flexibility,
a path forming unit connected to the liquid container stored in the storage unit and configured to form a path configured to flow a liquid out of the liquid container, and
a pressing unit configured to press the liquid container stored in the storage unit, and
the pressing unit is configured to perform:
a stirring operation of stirring the liquid stored in the liquid container by repeating pressing of the liquid container and reducing of the pressing; and
a regulating operation of maintaining a state in which the liquid container is pressed and regulating extraction of the liquid container from the storage unit.
